(19) United States
(12) Patent Application Publication
(10) Pub. No.: US 2025/0292384 A1
(43) Pub. Date: Sep. 18, 2025

(54) INFORMATION PROCESSING SYSTEM, INFORMATION PROCESSING METHOD, AND NON-TRANSITORY RECORDING MEDIUM

(71) Applicants: Kazuhiro Yoshida, KANAGAWA (JP); Makoto Odamaki, KANAGAWA (JP)

(72) Inventors: Kazuhiro Yoshida, KANAGAWA (JP); Makoto Odamaki, KANAGAWA (JP)

(73) Assignee: Ricoh Company, Ltd., Tokyo (JP)

(21) Appl. No.: 19/077,579

(22) Filed: Mar. 12, 2025

(30) Foreign Application Priority Data
Mar. 18, 2024 (JP) 2024-042213

(51) Int. Cl. G06T 7/00; G06T 5/00

(52) U.S. Cl. CPC G06T 7/0002; G06T 5/00; G06T 2207/30168

(57) ABSTRACT

An information processing system include circuitry to store, in a memory, setting information in which an abnormality in a captured image and a notification destination for the abnormality are associated with each other. The captured image is captured by an image capturing device. The circuitry detects the abnormality in the captured image and outputs, to the notification destination, a notification indicating that the abnormality has been detected.

### CROSS-REFERENCE TO RELATED APPLICATIONS

This patent application is based on and claims priority pursuant to 35 U.S.C. § 119 (a) to Japanese Patent Application No. 2024-042213, filed on Mar. 18, 2024, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

A monitoring camera system includes multiple image capturing devices and a system management terminal that performs system management control. The multiple image capturing devices and the system management terminal are connected via a network. In such a system, an abnormality occurring in an image captured by one of the multiple image capturing devices is detected by using image difference recognition technique to recognize a difference in the same area within the imaging range of images captured by the multiple image capturing devices, and an alert is issued to the system management terminal. In such a system, abnormality detection and issuing an alert are performed for the system management terminal. This method is implemented when the image capturing device is fixedly installed and operates as an unmanned monitoring camera. For example, in a case where the image capturing device moves and is operated by a person to perform imaging, an abnormality is detected at the imaging site, and an alert is issued. Some abnormality detection items can only be processed within the image capturing device.

### SUMMARY

According to an aspect of the disclosure, an information processing system includes circuitry to store, in a memory, setting information in which an abnormality in a captured image and a notification destination for the abnormality are associated with each other. The captured image is captured by an image capturing device. The circuitry detects the abnormality in the captured image and outputs, to the notification destination, a notification indicating that the abnormality has been detected.

According to an aspect of the disclosure, an information processing method includes storing, in a memory, setting information in which an abnormality in a captured image and a notification destination for the abnormality are associated with each other, detecting the abnormality in the captured image, and outputting, to the notification destination, a notification indicating that the abnormality has been detected.

According to an aspect of the disclosure, a non-transitory recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image processing system;

FIGS. 2A and 2B are diagrams illustrating a hemispherical image (front side) and a hemispherical image (back side), respectively, captured by an image capturing device;

FIG. 2C is a diagram illustrating an image represented by an equirectangular projection method;

FIG. 3A is a diagram illustrating an equirectangular projection image to cover a sphere;

FIG. 3B is a diagram illustrating a spherical image;

FIG. 4 is an illustration of the relative positions of a virtual camera and a predetermined area in a case where a spherical image is represented as a surface area of a three-dimensional solid sphere;

FIG. 5 is a diagram illustrating a relation between a predetermined-area information and an image of a predetermined area T;

FIG. 6 is a block diagram illustrating a hardware configuration of an image capturing device;

FIG. 7 is a block diagram illustrating a hardware configuration of each of a server and a communication terminal;

FIG. 8 is a block diagram illustrating a functional configuration of an image processing system;

FIG. 9 is a schematic diagram illustrating an example of a Twin management table;

FIG. 10 is a sequence diagram illustrating a Twin registration process;

FIGS. 11A and 11B are diagrams illustrating a projection relationship in an image capturing device using a fisheye lens;

FIGS. 12A and 12B are diagrams each illustrating a data structure of image data in a spherical image format;

FIG. 13 is a flowchart of generating a spherical image by stitching images captured by two fisheye lenses;

FIGS. 14A and 14B are diagrams illustrating a conversion table for converting a fisheye image into a spherical image;

FIG. 15 is a diagram illustrating mapping of two partial images captured by two fisheye lenses to a spherical coordinate system in position detection;

FIG. 16 is a diagram illustrating stitching position detection;

FIG. 17 is a diagram illustrating mapping of two partial images captured by two fisheye lenses to a spherical coordinate system in image stitching;

FIG. 18 is a sequence diagram illustrating a process of first abnormality detection;

FIG. 19 is a sequence diagram illustrating a process of first abnormality detection;

FIGS. 20A and 20B are diagrams each illustrating an example of an abnormality detection settings file;

FIG. 21 is a diagram illustrating an example of an abnormality detection settings screen;

FIG. 22 is a diagram illustrating another example of an abnormality detection settings screen;

FIG. 23 is a diagram illustrating an example of an abnormality management file;

FIGS. 24A and 24B are diagrams each illustrating an example of error codes for abnormality detection items;

FIGS. 25A, 25B, and 25C are diagrams each illustrating a recording format for detection data;

FIG. 26 is a sequence diagram illustrating a process of second abnormality detection;

FIG. 27 is a sequence diagram illustrating a process of second abnormality detection;

FIG. 28 is a sequence diagram illustrating a process of third abnormality detection;

FIG. 29 is a sequence diagram illustrating a process of third abnormality detection;

FIG. 30 is a sequence diagram illustrating a process of fourth abnormality detection; and

FIG. 31 is a sequence diagram illustrating a process of fourth abnormality detection.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the attached drawings. In the description of the drawings, like reference signs denote like elements, and redundant descriptions thereof are omitted.

### Overview of Image Processing System

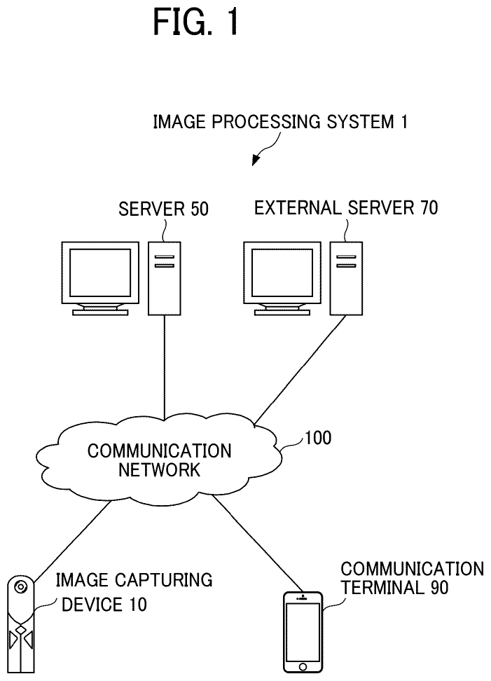

FIG. 1 is a diagram illustrating an overall configuration of an image processing system according to an embodiment of the present disclosure.

An image processing system 1 illustrated in FIG. 1 is an example of an information processing system, and is a system that performs image processing on a captured image for allowing a viewer to view, by online, an interior space of a structure such as a real estate property or a building or a structure such as construction or civil engineering.

As illustrated in FIG. 1, the image processing system 1 includes an image capturing device 10, a server 50, and a communication terminal 90 each of which can connected to an external server 70. The server 50 and the communication terminal 90 included in the image processing system 1 can communicate with each other via a communication network 100.

The server 50 can communicate with the external server 70 via a communication network 100. The image capturing device 10 can communicate with the communication terminal 90 by short-range wireless communication such as Wi-Fi, but may communicate with the server 50 and the communication terminal 90 via the communication network 100. The communication network 100 includes the Internet, a mobile communication network, and a local area network (LAN). The communication network 100 may include, in addition to a wired network, a wireless network in compliance with such as 3rd Generation (3G), 4th Generation (4G), 5th Generation (5G), WIRELESS FIDELITY (WI-FI), Worldwide Interoperability for Microwave Access (WiMAX), Long Term Evolution (LTE), etc.

The server 50 is an example of an information processing apparatus or a transmission destination apparatus, and is a server computer that stores imaging data representing a captured image obtained at a predetermined site, such as an image of an interior space of a structure such as a real estate property or a building or an image of a structure such as construction or civil engineering. For example, the server 50 obtains a captured image captured by the image capturing device 10 and generates a tour image to provide a virtual tour to a user, using the obtained captured image. The virtual tour is, for example, content that allows a user to view a real estate property as if the user were actually viewing the real estate property on the site. The tour image is generated by using multiple captured images that are captured by the image capturing device 10. The tour image is an image for being viewed by a user and that allows the user to virtually move in a site corresponding to the captured image according to an operation of the user. Such virtual tours can feasibly be implemented for external space or exterior spaces of structures, such as tourist spots and theme parks, not limited to interior spaces of structures of real estate properties or buildings. In other words, an interior space of a structure can be regarded as being within a predetermined area. When a virtual tour is carried out in an external space of exterior space of a structure, the present embodiment can be implemented by, for example, replacing a map indicating an interior space of a structure of a real estate property or a building, which is described later, with a tourist spot map introducing a tourist spot or an area map of a theme park.

The server 50 can be implemented by a single server computer or multiple server computers. In the following, the server 50 is described as a server computer residing on a cloud environment. However, the server 50 may be reside on an on-premises environment.

The image capturing device 10 is an example of an information processing apparatus or a transmission source apparatus, and a special digital camera (spherical image capturing device) that can obtain a spherical image (360-degree image in both the circumferential direction and the vertical direction) by capturing an image of a space in all directions in an image capturing site where a structure such as a real estate property is present. In the following description, a structure such as a real estate property is used, but the present disclosure may be applied to an interior space of a structure such as a real estate property or a building or a structure such as construction or civil engineering, as described above.

The spherical image refers to an image having a so-called solid angle 4 πsr [sr: steradian].

In the present specification, an image in which a partial area of the spherical image is missing is also referred to as a spherical image for the sake of convenience. Such an image includes an image in which a part of a direction directly above or below the spherical image capturing device is missing, an image in which a part of a vertically upward direction or a vertically downward direction of the spherical image is missing, and an image in which a part of a predetermined area of the spherical image is missing.

This is because considering, for example, a usage scenario in which a user does not carefully view a part that is immediately above or immediately below a subject captured in a spherical image when viewing the spherical image. In such a case, for example, it is also assumed that the spherical image itself is not displayed by designing an imaging element and an optical system so as not to capture the part, by not displaying an image, or by displaying a logo on the part.

The image capturing device 10 is used by, for example, a real estate agent that manages or sells real estate properties. The image capturing device 10 may be a wide-angle camera or a stereo camera that can obtain a wide-angle image having an angle of view equal to or greater than a predetermined value. The wide-angle image is typically an image captured with a wide-angle lens, such as a lens that can capture a range wider than a range that the human eye can perceive. In other words, the image capturing device 10 is an imaging device that can obtain an image (a spherical image or a wide-angle image) captured using a lens having a focal length shorter than a predetermined value. The wide-angle image is typically an image captured with a lens having a focal length of 35 mm or less in terms of 35 mm film. Further, the image capturing function of the image capturing device 10 may include a panoramic image capturing function to capture a panoramic image.

The communication terminal 90 is an example of an information processing apparatus or a transmission source apparatus, and is a computer such as a tablet terminal. The communication terminal 90 is used by, for example, the same real estate agent as the image capturing device 10. In the communication terminal 90, for example, a dedicated application for instructing the image capturing device 10 to capture an image and viewing an image provided from the server 50 is installed.

Alternatively, the communication terminal 90 may instruct to capture an image and allow a user to view an image by accessing a dedicated website using a web browser without the dedicated application. Further, instructing to capture an image and allowing a user to view an image may be performed by an additional or a different communication terminal 90.

The communication terminal 90 is not limited to a tablet terminal, and may be, for example, a personal computer (PC), a smartphone, a wearable terminal, a head mount display (HMD), or an interactive white board (IWB: an electronic whiteboard having mutual communication capability).

### Overview of Image Capturing Device

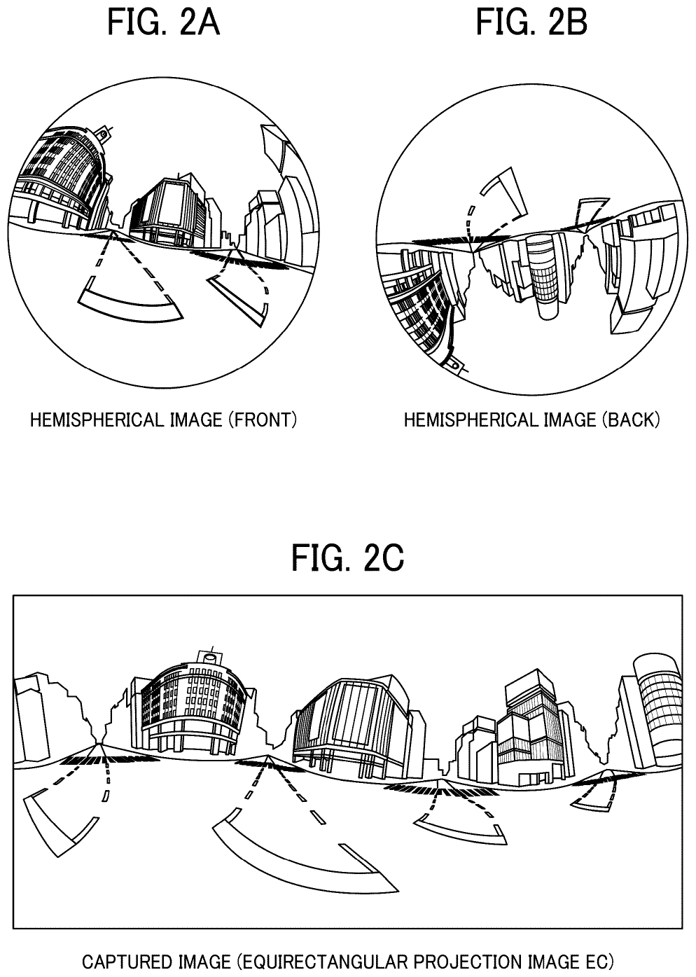

An overview of the image capturing device 10 included in the image processing system 1 is described with reference to FIGS. 2 to 5. The image capturing device 10 captures a spherical image. There are various forms of spherical images, but the spherical images are often generated using an equirectangular projection, which is described later. An image generated by the equirectangular projection is advantageous because its outer shape is rectangular, allowing for efficient and easy storage of image data. Additionally, the image appears relatively natural as the distortion near the equator is minimal, and vertical straight lines remain undistorted.

### Overview of Spherical Image

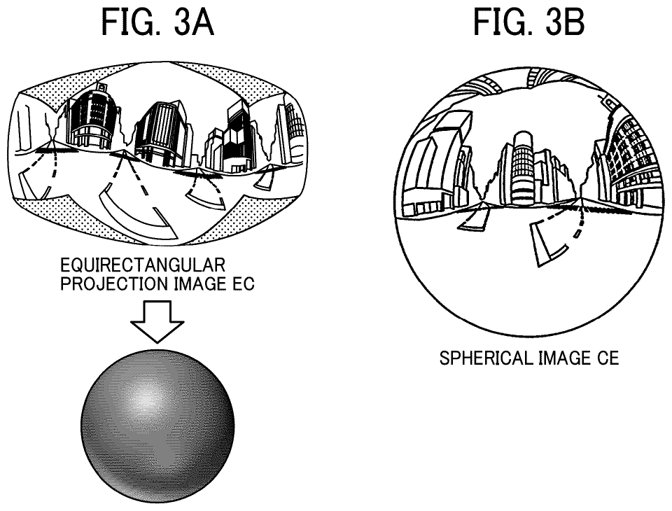

An overview of the spherical image is described below. Referring to FIGS. 2A to 2C and FIGS. 3A and 3B, an overview of a method for generating a spherical image from an image captured by the image capturing device 10 is described. FIG. 2A is a diagram illustrating a hemispherical image (front side) captured by the image capturing device 10. FIG. 2B is a diagram illustrating a hemispherical image (back side) captured by the image capturing device 10. FIG. 2C is a diagram illustrating an image in equirectangular projection. The image in equirectangular projection may be referred to as an “equirectangular projection image.” FIG. 3A is a diagram illustrating an equirectangular projection image to cover a sphere. FIG. 3B is a diagram illustrating a spherical image.

The image capturing device 10 is provided with an imaging element on each of a front surface side (front side) and a back surface side (back side). These imaging elements (image sensors) are used in combination with optical members each can capture a hemispherical image having an angle of view of 180 degrees or wider. The image capturing device 10 obtains two hemispherical images by capturing a subject around the user by the two imaging elements.

As illustrated in FIGS. 2A and 2B, images captured by the imaging elements of the image capturing device 10 are curved hemispherical images (front side and back side). The image capturing device 10 combines the hemispherical image (front side) and the hemispherical image (back side) inverted by 180 degrees to create an equirectangular projection image EC as illustrated in FIG. 2C.

The image capturing device 10 uses Open Graphics Library for Embedded Systems (OpenGL ES) to map the equirectangular projection image EC in a manner that the sphere surface is covered as illustrated in FIG. 3A, to generate a spherical image (spherical panoramic image) CE as illustrated in FIG. 3B. In other words, the spherical image CE is represented as an image corresponding to the equirectangular projection image EC oriented toward the center of the sphere. OpenGL ES is a graphics library used for visualizing 2-dimensional (2D) data and 3-dimensional (3D) data. The spherical image CE is either a still image or a moving image. Furthermore, the conversion method is not limited to OpenGL ES and may include any method for converting a hemispherical image into an equirectangular projection, such as calculations by a CPU or Open Compute Language (OpenCL).

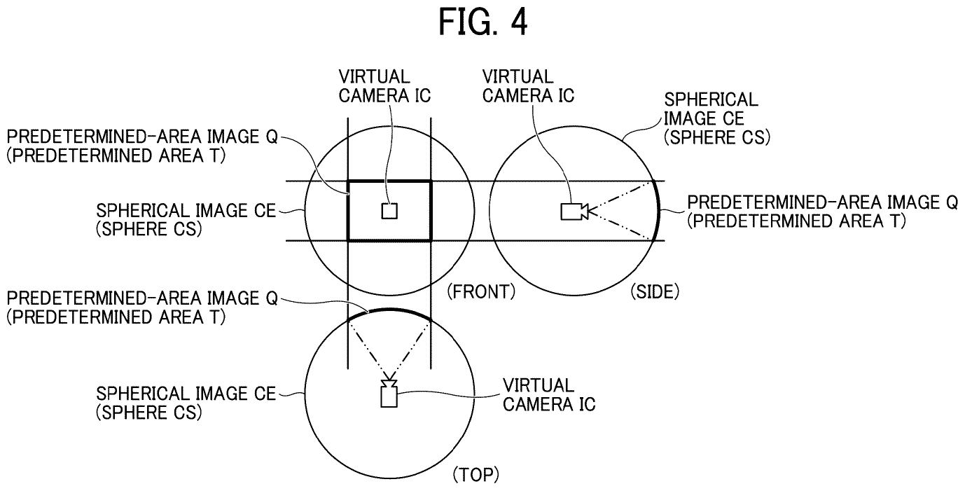

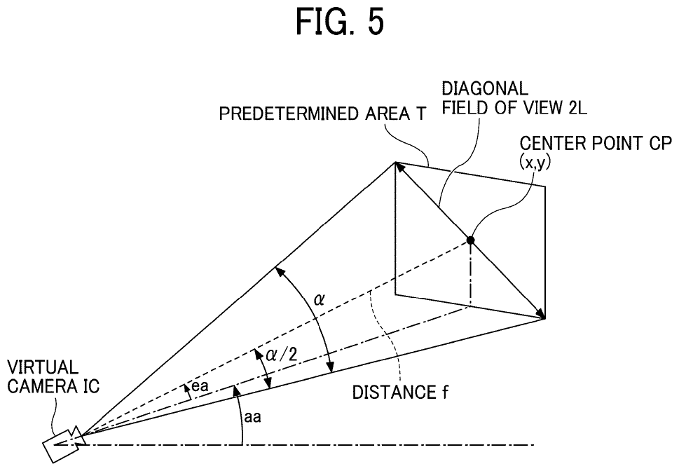

As described above, since the spherical image CE is an image mapped to the sphere surface to cover the sphere surface, a part of the image may look distorted when viewed by the user, giving a feeling of strangeness. To resolve this strange feeling, the image capturing device 10 displays an image of a predetermined area T, which is a part of the spherical image CE, as a planar image having fewer curves. The predetermined area is described below with reference to FIGS. 4 and 5.

FIG. 4 is an illustration of relative positions of a virtual camera and a predetermined area when a spherical image is represented as a three-dimensional solid sphere. A virtual camera IC corresponds to a position of the viewpoint of a user who is viewing the spherical image CE represented as a surface area of a three-dimensional solid sphere. In FIG. 4, the spherical image CE is represented as a surface area of a three-dimensional solid sphere CS. Assuming that the spherical image CE having been generated is the surface area of a solid sphere CS, the virtual camera IC is inside of the spherical image CE as illustrated in FIG. 4. The predetermined area T in the spherical image CE is an imaging area of the virtual camera IC. Specifically, the predetermined area T is specified by predetermined-area information indicating an imaging direction and an angle of view of the virtual camera IC in a three-dimensional virtual space containing the spherical image CE. Further, zooming in the predetermined area T is also expressed by bringing the virtual camera IC closer to or away from the spherical image CE. A predetermined-area image Q is an image of the predetermined area T in the spherical image CE. The predetermined area T is defined by an angle of view a and a distance f from the virtual camera IC to the spherical image CE.

The predetermined-area image Q is displayed on a predetermined display as an image representing the imaging area of the virtual camera IC. In the following description of the present embodiment, an imaging direction (ea, aa) and the angle of view a of the virtual camera IC are used. In another example, the predetermined area T is identified by an imaging area (X, Y, Z) of the virtual camera IC, i.e., the predetermined area T, rather than the angle of view a and the distance f.

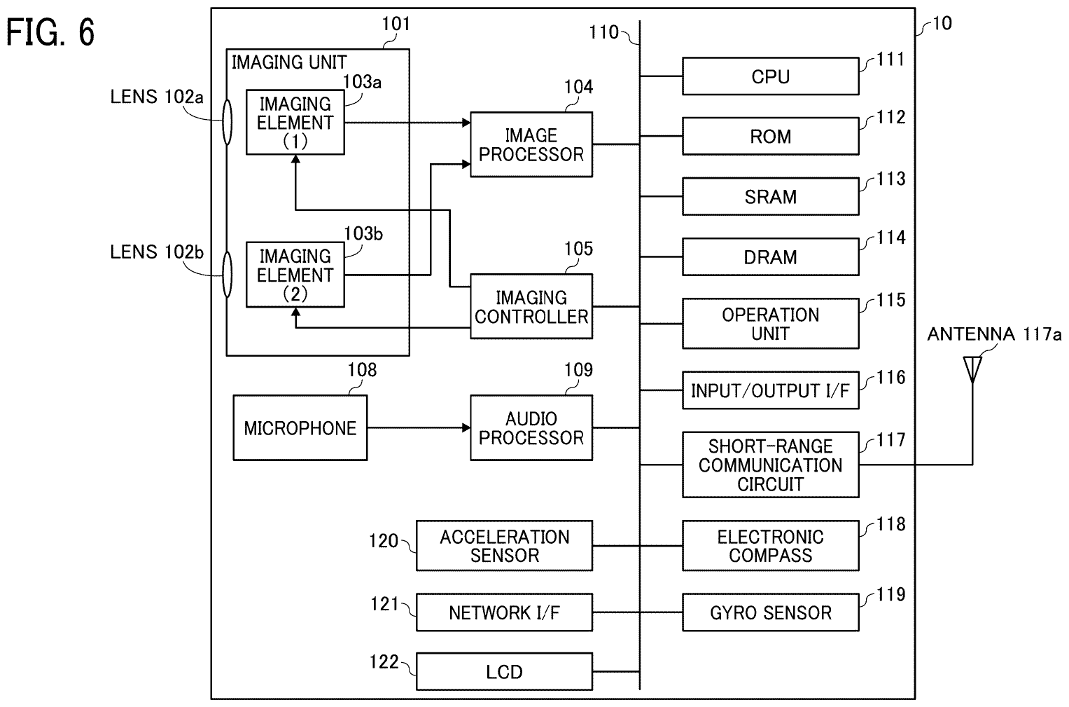

A relation between the predetermined-area information and the image of the predetermined area T is described below with reference to FIG. 5. FIG. 5 is a diagram illustrating a relation between the predetermined-area information and the image of the predetermined area T. As illustrated in FIG. 5, “ea” refers to an elevation angle, “aa” refers to an azimuth angle, and “a” refers to an angle of view. The position of the virtual camera IC is adjusted, such that the point of gaze of the virtual camera IC, indicated by the imaging direction (ea, aa), matches the center point CP (x, y) of the predetermined area T as the imaging area of the virtual camera IC. As illustrated in FIG. 6, when it is assumed that a diagonal angle of the predetermined area T specified by the angle of view α of the virtual camera IC is α, the center point CP (x, y) provides the parameters (x, y) of the predetermined-area information. The predetermined-area image Q is an image of the predetermined area T in the spherical image CE, and “f” denotes the distance between the virtual camera IC and the center point CP (x, y). “L” is a distance between the center point CP (x, y) and a given vertex of the predetermined area T (2L is a diagonal line). In FIG. 5, a trigonometric function equation typically expressed by the following formula 1 is satisfied.

L/f=tan (α/2) (Formula 1)

### Hardware Configuration

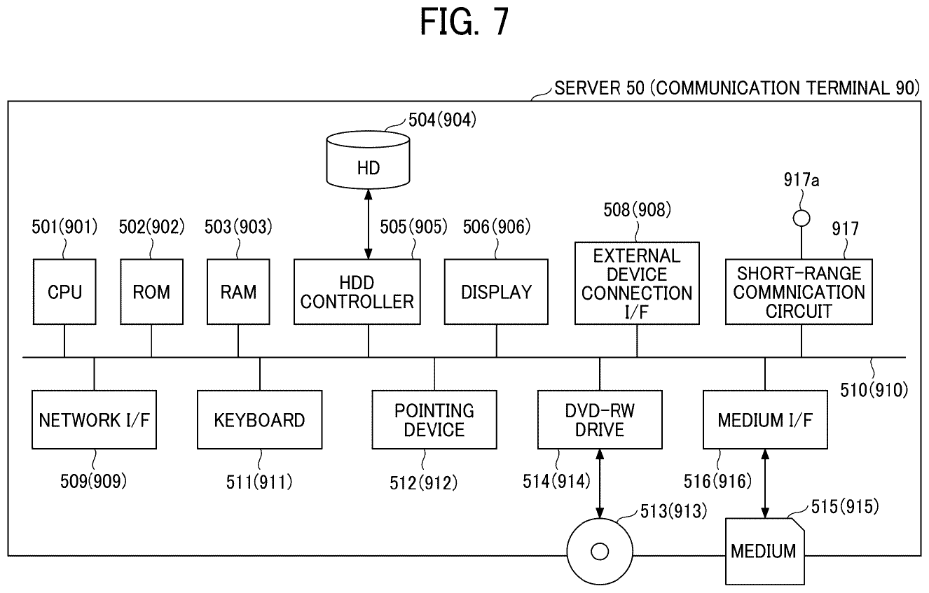

Hardware configurations of each apparatus, device, and terminal of the image processing system 1 are described below with reference to FIGS. 6 and 7. In the hardware configurations illustrated in FIG. 6 and FIG. 7, components or elements may be added or deleted as appropriate.

### Hardware Configuration of Image Capturing Device

Referring to FIG. 6, a hardware configuration of the image capturing device 10 is described below. FIG. 6 is a block diagram illustrating a hardware configuration of an image capturing device according to the present embodiment. In the following description, the image capturing device 10 that is a spherical (omnidirectional) image capturing device having two imaging elements is used. However, the image capturing device 10 may have more than two imaging elements. The image capturing device 10 is not necessarily an image capturing device dedicated to omnidirectional image capturing. An external omnidirectional image capturing unit may be attached to a general-purpose digital camera or a smartphone to implement an image capturing device having substantially the same function as that of the image capturing device 10.

As illustrated in FIG. 6, the image capturing device 10 includes an imaging unit 101, an image processor 104, an imaging controller 105, a microphone 108, an audio processor 109, a central processing unit (CPU) 111, a read-only memory (ROM) 112, a static random-access memory (SRAM) 113, a dynamic random-access memory (DRAM) 114, an operation unit 115, an input/output interface (I/F) 116, a short-range communication circuit 117, an antenna 117a for the short-range communication circuit 117, an electronic compass 118, a gyro sensor 119, an acceleration sensor 120, a network I/F 121, and a liquid crystal display (LCD) 122. The image capturing device 10 further includes an image signal processor (ISP) that is a processor to process an image signal.

The imaging unit 101 includes optical systems (wide-angle lenses or so-called fisheye lenses) 102a and 102b (collectively referred to as lens 102 unless they need to be distinguished from each other), each having an angle of view of equal to or greater than 180 degrees to form a hemispherical image. The imaging unit 101 further includes two imaging elements 103a and 103b corresponding to the lenses 102a and 102b respectively. In the description of the present embodiment, a combination of a single optical system and a single imaging element is referred to as an imaging optical system, and the image capturing device 10 can be implemented by arranging two imaging optical systems to face each other. The image capturing device 10 may be implemented by using two or more imaging optical systems. Each of the imaging elements 103a and 103b includes an imaging sensor such as a complementary metal oxide semiconductor (CMOS) sensor and a charge-coupled device (CCD) sensor, a timing generation circuit, and a group of registers. The imaging sensor converts an optical image formed by the lenses 102a and 102b into electrical signals to output image data. The timing generation circuit generates, for example, horizontal or vertical synchronization signals or pixel clocks for the imaging sensor. Various commands and parameters for operations of the imaging elements 103a and 103b are set in the group of registers.

Each of the imaging elements 103a and 103b of the imaging unit 101 is connected to the image processor 104 via a parallel I/F bus. Further, each of the imaging elements 103a and 103b of the imaging unit 101 is connected to the imaging controller 105 via a serial I/F bus such as an internet integrated circuit (I2C) bus. The image processor 104, the imaging controller 105, and the audio processor 109 are each connected to the CPU 111 via a bus 110. Furthermore, the ROM 112, the SRAM 113, the DRAM 114, the operation unit 115, the input/output I/F 116, the short-range communication circuit 117, the electronic compass 118, the gyro sensor 119, the acceleration sensor 120, the network I/F 121, and the LCD 122 are also connected to the bus 110.

The image processor 104 acquires image data from each of the imaging elements 103a and 103b via the parallel I/F bus and performs predetermined processing on each image data. Thereafter, the image processor 104 stitches the image data to generate data of the equirectangular projection image as illustrated in FIG. 2C.

The imaging controller 105 functions as a master device while each of the imaging elements 103a and 103b functions as a slave device, and the imaging controller 105 sets commands in the group of registers of each of the imaging elements 103a and 103b through the I2C bus. The image controller 105 receives commands from the CPU 111. The imaging controller 105 obtains status data of the group of registers of each of the imaging elements 103a and 103b through the I2C bus and transmits the status data to the CPU 111.

The imaging controller 105 instructs the imaging elements 103a and 103b to output the image data at a time when the shutter button of the operation unit 115 is pressed. In some cases, the image capturing device 10 displays a preview image on a display (e.g., the LCD 122, a display of an external terminal such as a smartphone that performs short-range communication with the image capturing device 10 through the short-range communication circuit 117) or displays a moving image (movie). In case of displaying moving image, the image data is continuously output from the imaging elements 103a and 103b at a predetermined frame rate (frames per second).

Further, the imaging controller 105 operates in conjunction with the CPU 111 to synchronize the output timings of image data between the imaging elements 103a and 103b. The microphone 108 converts sound into audio data (signals). The audio processor 109 obtains the audio data from the microphone 108 through an I/F bus and performs predetermined processing on the audio data.

The CPU 111 controls the entire operation of the image capturing device 10 and executes predetermined processing.

The ROM 112 stores various programs for execution by the CPU 111. Each of the SRAM 113 and the DRAM 114 operates as a working memory to store programs to be executed by the CPU 111 or data currently processed. More specifically, in one example, the DRAM 114 stores image data currently processed by the image processor 104 and equirectangular projection image data on which processing has been performed.

The operation unit 115 collectively refers to various operation buttons, a power switch, a shutter button, and a touch panel that functions both as a display for information and as an input device, and can be used in combination. The operation unit 115 allows the user operating the operation unit 115 to input various image capturing (imaging) modes or image capturing (imaging) conditions.

The input/output I/F 116 collectively refers to an interface circuit, such as a secure digital (SD) memory card I/F or a universal serial bus (USB) I/F for an external medium, such as a SD memory card, or a personal computer. The input/output I/F 116 supports at least one of wired and wireless communications. The equirectangular projection image data stored in the DRAM 114 can be stored in an external medium via the input/output I/F 116 or transmitted to an external terminal (apparatus) via the input/output I/F 116, as appropriate.

The short-range communication circuit 117 communicates data with the external terminal (apparatus) via the antenna 117a of the image capturing device 10 by short-range wireless communication such as near field communication (NFC), BLUETOOTH (registered trademark), and Wi-Fi. The short-range communication circuit 117 transmits the equirectangular projection image data to the external terminal (apparatus).

The electronic compass 118 calculates the orientation of the image capturing device 10 from the Earth's magnetism to output orientation information. This orientation information is an example of related information, which is metadata described in compliance with Exif. This information is used for image processing such as image correction of captured images. The related information also includes an imaging date and time, that indicates the date and time when the image is captured, and a data size of the image data. The gyro sensor 119 detects the change in tilt of the image capturing device 10 (roll, pitch, yaw) with movement of the image capturing device 10. The change in tilt is one example of the related information (metadata) described in compliance with Exif, and used for image processing such as image correction performed on a captured image. The acceleration sensor 120 detects acceleration in three axial directions. The image capturing device 10 calculates position (an angle with respect to the direction of gravity) of the image capturing device 10, based on the acceleration detected by the acceleration sensor 120. With the acceleration sensor 120, the image capturing device 10 can enhance accuracy of image correction. The network I/F 121 is an interface for data communication via such as a router using the communication network 100 such as the Internet. The LCD 122 can display imaging settings for the image capturing device 10 and an image or a moving image captured by the image capturing device 10.

### Hardware Configuration of Server

A hardware configuration of the server 50 is described below with reference to FIG. 7. FIG. 7 is a block diagram illustrating a hardware configuration of a server. Each of the components of the hardware configuration of the server 50 is denoted by a reference numeral in 500 series. The server 50 is implemented by a computer, and as illustrated in FIG. 7, includes a CPU 501, a ROM 502, a RAM 503, a hard disk (HD) 504, an hard disk drive) HDD controller 505, a display 506, an external device connection I/F 508, a network I/F 509, a bus line 510, a keyboard 511, a pointing device 512, a digital versatile disk Rewritable (DVD-RW) drive 514, and a medium I/F 516.

The CPU 501 controls entire operation of the server 50. The ROM 502 stores programs such as an initial program loader (IPL) used for driving the CPU 501. The RAM 503 is used as a working area for the CPU 501. The HD 504 stores various types of data such as a program. The HDD controller 505 controls the reading or writing of various types of data to or from the HD 504 under the control of the CPU 501. The display 506 displays various information such as a cursor, a menu, a window, characters, or an image. The display 506 may be a touch panel display provided with an input device. The external device connection I/F 508 is an interface that connects to various external apparatuses (devices). Examples of the external devices include, but are not limited to, a USB memory. The network I/F 509 is an interface that controls communication of data with an external device through the communication network 100. The bus line 510 is, for example, an address bus or a data bus, which electrically connects components such as the CPU 501 illustrated in FIG. 7.

The keyboard 511 is an example of an input device and includes multiple keys for inputting, for example, characters, numerical values, and various instructions. The pointing device 512 is an example of an input device that allows a user to select or execute a specific instruction, select a target for processing, or move a cursor being displayed. The input device is not limited to the keyboard 511 and the pointing device 512, and may be a touch panel, or a voice input device. The DVD-RW drive 514 controls the reading or writing of various types of data to or from a DVD-RW 513, which is an example of a removable recording medium. The removable recording medium is not limited to the DVD-RW and may be a digital versatile disk-recordable (DVD-R), or a BLU-RAY (registered trademark) disc (BLU-RAY disk), for example. The medium I/F 516 controls the reading or writing (storing) of data from or to a storage medium (recording medium) 515 such as a flash memory.

### Hardware Configuration of Communication Terminal

FIG. 7 is a block diagram illustrating a hardware configuration of the communication terminal 90. Each hardware component of the hardware configuration of the communication terminal 90 is denoted by a reference numeral in 900 series. The communication terminal 90 is implemented by a computer and has the same configuration as that of the server 50 as illustrated in FIG. 7, and thus the description of each of the components of the hardware configuration is omitted. The communication terminal 90 includes a short-range communication circuit 917 and an antenna 917a of the short-range communication circuit 917 in addition to the same configuration as the server 50. The short-range communication circuit 917 is a communication circuit that communicates in compliance with, for example, a Near Field Communication (NFC) or the BLUETOOTH.

Each of the above-described control programs may be recorded in a file in a format installable or executable on a computer-readable recording medium for distribution. Examples of the recording medium include a compact disc-recordable (CD-R), a DVD, a BLU-RAY Disc, an SD card, and a USB memory. Further, such recording medium may be provided as a program product to users both within and outside a certain country. For example, the server 50 implements an image processing method according to the present disclosure by executing a program.

### Functional Configuration

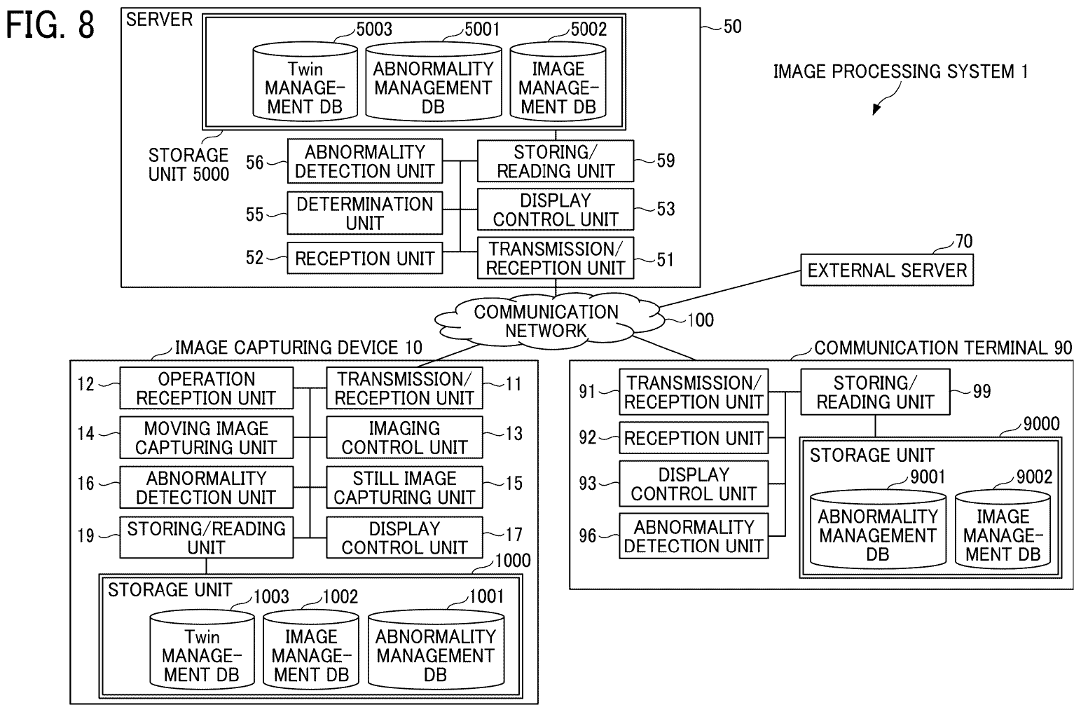

A functional configuration of the image processing system according to the present embodiment is described below with reference to FIG. 8. FIG. 8 is a block diagram illustrating a functional configuration of an image processing system. FIG. 8 illustrates a part of the apparatuses and terminals of FIG. 1, which are related to the processing or operation to be described below.

### Functional Configuration of Image Capturing Device

A functional configuration of the image capturing device 10 is described below with reference to FIG. 8. The image capturing device 10 includes a transmission/reception unit 11, an operation reception unit 12, an imaging control unit 13, a moving image capturing unit 14, a still image capturing unit 15, an abnormality detection unit 16, a display control unit 17, and a storing/reading unit 19. Each of the above-mentioned units is a function or a device that is implemented by operating any one or more of the components illustrated in FIG. 6 according to instructions from the CPU 111 executing a control program for an image capturing device, which is expanded from the SRAM 113 to the DRAM 114. The image capturing device 10 further includes a storage unit 1000 implemented by the ROM 112, the SRAM 113, or the DRAM 114 illustrated in FIG. 6. The storage unit 1000 stores a Globally Unique Identifier (GUID) identifying the own device.

The transmission/reception unit 11 is an example of a transmission unit and a reception unit, is implemented by, for example, processing of the CPU 111 and transmits and receives various types of data or information to and from another apparatus or terminal. The transmission/reception unit 11 exchanges data with another apparatus or terminal through the communication network 100 via the network I/F 121.

The operation reception unit 12 is implemented by, for example, processing of the CPU 111 with respect to the operation unit 115, and receives an operation for various selection or input performed by a user who is an operator of the image capturing device 10 for imaging.

The imaging control unit 13 is implemented by, for example, the imaging unit 101, the image processor 104, and the imaging controller 105 each operating according to instructions of the CPU 111. The imaging control unit 13 captures an image of a subject such as surroundings (for example, scenery) to obtain captured image data. For example, the imaging control unit 13 performs imaging by switching between moving image capturing by the moving image capturing unit 14 and still image capturing by the still image capturing unit 15 in a time division manner.

The moving image capturing unit 14 is implemented by, for example, processing of the CPU 111 with respect to the imaging unit 101, the image processor 104, and the imaging controller 105 and captures a moving image.

The still image capturing unit 15 is implemented by, for example, processing of the CPU 111 with respect to the imaging unit 101 and captures an image of a subject such as surroundings (for example, scenery) to capture a still image. For example, the still image capturing unit 15 captures a still image (photograph) with a resolution greater than the moving image captured by the moving image capturing unit 14, and stores the captured image data in the storage unit 1000. The still image captured by the still image capturing unit 15 may be an image of one frame, or may be a high dynamic range (HDR) image obtained by combining a plurality of images.

The abnormality detection unit 16 is implemented by, for example, processing of the CPU 111, and performs various abnormality detection, which is described later, based on the still images captured by the still image capturing unit 15 and the moving images captured by the moving image capturing unit 14.

The display control unit 17 is implemented by, for example, processing of the CPU 111 and controls the LCD 122 to display various screens including various images or texts. The display control unit 17 displays, for example, an image corresponding to the date distributed from the server 50 on the LCD 122.

The storing/reading unit 19 an example of a setting unit, is implemented by, for example, processing of the CPU 111, stores various types of data (or information) in the storage unit 1000, and reads various types of data (or information) from the storage unit 1000. The storage unit 1000 also stores image data obtained by the moving image capturing unit 14 and the still image capturing unit 15. The image data stored in the storage unit 1000 is associated with an imaging time of captured image as metadata.

The storage unit 1000 includes an abnormality management database (DB) 1001, an image management DB 1002, and a Twin management DB 1003. The abnormality management DB 1001 includes an abnormality management table, which is described later, and stores and manages information on abnormality detection executed by the abnormality detection unit 16.

The image management DB 1002 stores and manages a captured image captured by the image capturing device 10 and a processed image obtained by image processing performed by the abnormality detection unit 16 on the captured image in association with the image IDs. The captured image and the processed image may be stored in a recording medium such as an SD memory card, which is an external medium as described above.

In the Twin management DB 1003, a Twin ID for identifying a Twin is managed in association with a user ID. The Twin indicates a function of holding information such as metadata, a configuration, and a status regarding an actual device such as the image capturing device 10, in the server 50, which is described in detail later.

### Functional Configuration of Server

A functional configuration of the server 50 is described below with reference to FIG. 8. The server 50 includes a transmission/reception unit 51, a reception unit 52, a display control unit 53, a determination unit 55, an abnormality detection unit 56, and a storing/reading unit 59. Each of these units is a function or a device that is implemented by operating any of the components illustrated in FIG. 7 according to instructions from the CPU 501 executing a control program for a server expanded from the HD 504 to the RAM 503. The server 50 further includes a storage unit 5000 that is implemented by the ROM 502, the RAM 503, or the HD 504 illustrated in FIG. 7.

The transmission/reception unit 51 is an example of a transmission unit and a reception unit, is implemented by, for example, processing of the CPU 501 with respect to the network I/F 509, and transmits and receives various types of data or information to and from another apparatus or terminal through the communication network 100. For example, the transmission/reception unit 51 receives (acquires) a moving image captured by the image capturing device 10 from the image capturing device 10 or the communication terminal 90. Further, for example, the transmission/reception unit 51 receives (acquires) a still image captured by the image capturing device 10 from the image capturing device 10 or the communication terminal 90.

The reception unit 52 is implemented by, for example, processing of the CPU 501 with respect to the keyboard 511 or the pointing device 512 and receives various selections or inputs from users.

The display control unit 53 is implemented by, for example, processing of the CPU 501 and controls the display 506 to display various screens including various images or texts.

The display control unit 53 displays, for example, an image corresponding to the date generated by the server 50 on the display 506.

The determination unit 55 is implemented by processing of the CPU 501 and performs various determinations.

The abnormality detection unit 56 is implemented by, for example, processing of the CPU 501 and performs abnormality detection on imaging data (still image, moving image). The abnormality detection is described later.

The storing/reading unit 59 is an example of a setting unit, is implemented by, for example, processing of the CPU 501, stores various types of data (or information) in the storage unit 5000, and reads various types of data (or information) from the storage unit 5000.

The storage unit 5000 includes an abnormality management DB 5001, an image management DB 5002, and a Twin management DB 5003. The abnormality management DB 5001 includes an abnormality management table, which is described later, and stores and manages information on abnormality detection executed on a still image or a moving image by the abnormality detection unit 56.

The image management DB 5002 stores and manages a captured image (still image, moving image) received from the image capturing device 10 or the communication terminal 90 in association with the image ID.

The image stored in the image management DB 5002 may be transmitted to the image capturing device 10 and stored in the image management DB 1002 or transmitted the communication terminal 90 and stored in an image management DB 9002. The image may be stored in a recording medium such as a SD memory card.

In the Twin management DB 5003, a Twin ID for identifying a Twin is managed in association with a user ID and a model ID for identifying the image capturing device 10.

### Functional Configuration of Communication Terminal

A functional configuration of the communication terminal 90 is described below with reference to FIG. 8. The communication terminal 90 includes a transmission/reception unit 91, a reception unit 92, a display control unit 93, an abnormality detection unit 96, and a storing/reading unit 99. Each of these units is a function or a device that is implemented by operating any one or more of the components illustrated in FIG. 8 according to instructions from the CPU 901 executing a control program for a communication terminal expanded from the HD 904 to the RAM 903. The communication terminal 90 also includes a storage unit 9000 implemented by the ROM 902, the RAM 903, or the HD 904 illustrated in FIG. 7.

The transmission/reception unit 91 is an example of a transmission unit and a reception unit, is implemented by, for example, processing of the CPU 901 with respect to the network I/F 909, and transmits and receives various types of data or information to and from another apparatus or terminal through the communication network 100.

The reception unit 92 is an example of a setting unit, is implemented by, for example, processing of the CPU 901 with respect to the keyboard 911 or the pointing device 912, and receives various selections or inputs from users.

The display control unit 93 is implemented by, for example, processing of the CPU 901 and controls the display 906 to display various screens including various images or texts. The display control unit 93 accesses the server 50 using, for example, a web browser or a dedicated application, and causes the display 906 to display an image corresponding to data distributed from the server 50.

The abnormality detection unit 96 is implemented by, for example, processing of the CPU 901 and performs abnormality detection on a still image or a moving image. The abnormality detection is described later.

The storing/reading unit 99 is implemented by, for example, processing of the CPU 901 and stores various types of data (or information) in the storage unit 9000 or reads various types of data (or information) from the storage unit 9000.

The storage unit 9000 includes an abnormality management DB 9001 and an image management DB 9002. The abnormality management DB 9001 includes an abnormality management table, which is described later, and stores and manages information on abnormality detection performed by the abnormality detection unit 96.

The image management DB 9002 stores and manages a captured image captured by the image capturing device 10 and received from the image capturing device 10 in association with the image ID. A captured image and a processed image may be stored in a recording medium such as an SD memory card, which is an external medium.

The image processing system 1 described above has a Twin function. The Twin function is a function of holding information such as metadata, a configuration, and a status regarding an actual device such as the image capturing device 10, in the server 50. As a result, a twin of the image capturing device 10 is digitally generated in the server 50.

The actual device (the image capturing device 10) and the Twin (the server 50) are synchronized via the communication network 100. The information to be synchronized further includes information on an image (still image or moving image) or imaging.

The server 50 and the image capturing device 10 can directly communicate with each other by the Twin function, and image data obtained by the image capturing device 10 is directly uploaded to the Twin to be reflected, a change in settings for the image capturing device 10 is reflected on the Twin, and a change in settings for the Twin is reflected on the image capturing device 10.

In FIG. 8, the functional units that cause the server 50 to function as a Twin are the transmission/reception unit 51, the reception unit 52, the determination unit 55, the storing/reading unit 59, and the storage unit 5000. In FIG. 7, the hardware components that cause the server 50 to function as a Twin are the CPU 501, the ROM 502, the RAM 503, the network I/F 509, the HDD controller 505, and the HD 504.

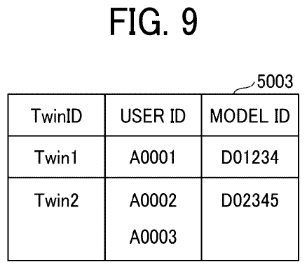

FIG. 9 is a schematic diagram illustrating an example of a Twin management table.

The Twin management table illustrated in FIG. 9 is included in the Twin management DB 5003 included in the storage unit 5000 of the server 50 illustrated in FIG. 8.

In the Twin management table included in the Twin management DB 5003, Twin IDs each identifying a Twin is managed in association with a user ID and a model ID for identifying the corresponding image capturing device 10.

Further, in a Twin management table included in the Twin management DB 1003 included in the storage unit 1000 of the image capturing device 10 illustrated in FIG. 8, the Twin IDs each identifying a twin is managed in association with a user ID.

The user ID may be shared by a team of multiple members. The user ID may be used as a team ID, and an ID for identifying an individual may be associated with the user ID in a lower layer.

In FIG. 9, one or more user IDs and one image capturing device are assigned to a single Twin ID. Multiple Twin IDs may be assigned to a single user.

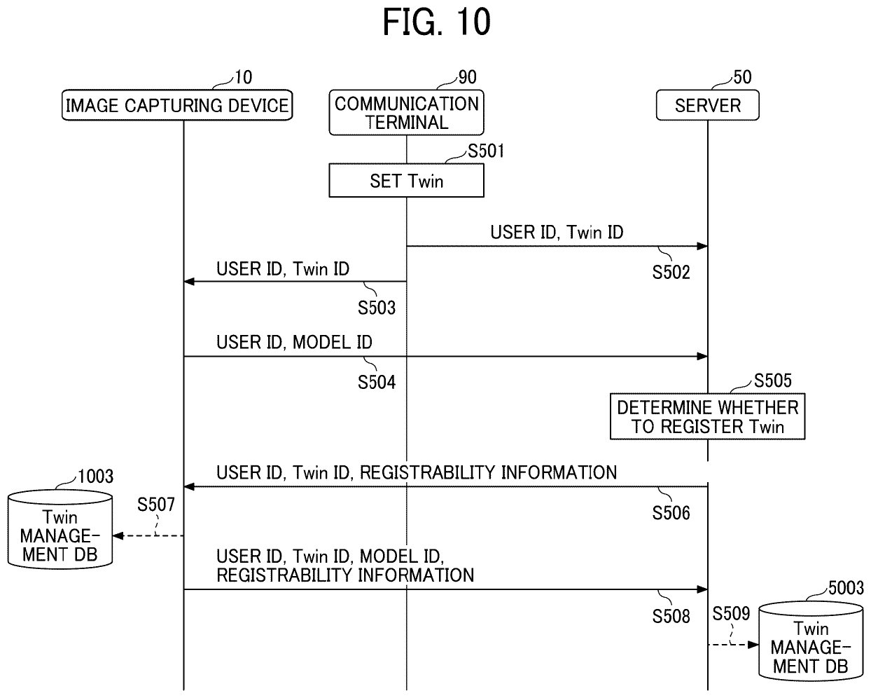

FIG. 10 is a sequence diagram illustrating a Twin registration process.

The reception unit 92 of the communication terminal 90 receives information set by a user inputting a user ID and a Twin ID (Step S501).

The transmission/reception unit 91 transmits the user ID and the Twin ID received in Step S501 to the server 50, and the transmission/reception unit 51 of the server 50 receives the user ID and the Twin ID transmitted from the communication terminal 90 (Step S502).

The transmission/reception unit 91 of the communication terminal 90 transmits the user ID and the Twin ID received in Step S501 to the image capturing device 10, and the transmission/reception unit 11 of the image capturing device 10 receives the user ID and the Twin ID transmitted from the communication terminal 90 (Step S503).

The transmission/reception unit 11 of the image capturing device 10 transmits the Twin ID received in Step S503 and the model ID to the server 50, and the transmission/reception unit 51 of the server 50 receives the Twin ID and the model ID transmitted from the image capturing device 10 (Step S504).

The determination unit 55 of the server 50 determines whether Twin registration can be performed based on the user ID received in Step S502 and the model ID received in Step S504 (Step S505). When the determination indicates that the registration can be performed, the transmission/reception unit 51 transmits the user ID, the Twin ID, and registrability information indicating that the Twin can be registered to the image capturing device 10, and the transmission/reception unit 11 of the image capturing device 10 receives the user ID, the Twin ID, and the registrability information transmitted from the server 50 (Step S506).

The storing/reading unit 19 stores and registers the Twin ID and the user ID received in Step S506 in the Twin management DB 1003 in association with each other based on the registrability information received in Step S506 (Step S507).

The transmission/reception unit 11 of the image capturing device 10 transmits to the server 50 registration completion information indicating that the user ID, the Twin ID, the model ID, and the Twin ID have been registered, and the transmission/reception unit 51 of the server 50 receives the user ID, the Twin ID, the model ID, and the registration completion information transmitted from the image capturing device 10 (Step S508).

The storing/reading unit 59 stores and registers the Twin ID, the model ID, and the user ID received in Step S508 in the Twin management DB 5003 in association with each other based on the registration completion information received in Step S508 (Step S509).

### Spherical Image Generation

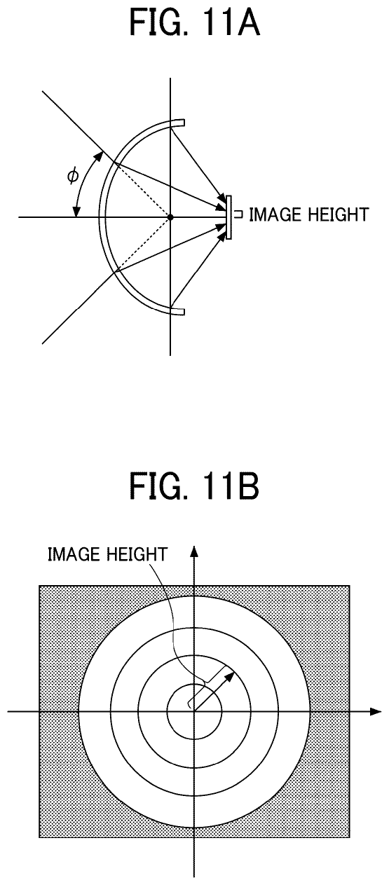

A method for generating a spherical image from images captured by multiple fisheye lenses is described below with reference to FIGS. 11A to 17. In the present embodiment, two fisheye lenses are used, but the present disclosure is not limited thereto.

FIGS. 11A and 11B are diagrams illustrating a projection relationship in the image capturing device 10 in the image processing system 1. An image captured by a single fisheye lens represents approximately a hemispherical range of directions from the image capturing point. As illustrated in FIG. 11A, with a fisheye lens, an image having an image height h that corresponds to an angle of incidence q with respect to an optical axis is generated. The relation between the image height h and the angle of incidence q is determined by a projection function according to a prescribed projection model. Further, in the present embodiment, it is assumed that a so-called circular fisheye lens having an image circle diameter shorter than a diagonal line of an image is adopted. As illustrated in FIG. 11B, a partial image obtained with such a lens is a planar image including the entire image circle onto which approximately a hemispherical portion of the image capturing range is projected.

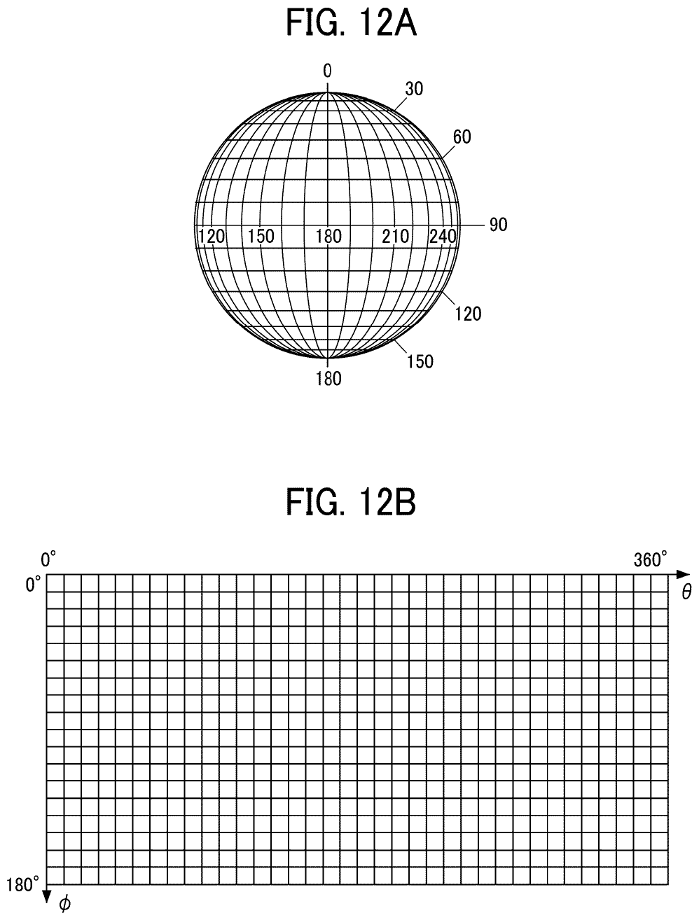

FIGS. 12A and 12B are diagrams each illustrating a data structure of an equidistant cylindrical projection image in a spherical image format. As illustrated in FIGS. 12A and 12B, the equidistant cylindrical projection image is expressed as an array of pixel values where the vertical angle φ corresponding to the angle with respect to a certain axis and the horizontal angle θ corresponding to the angle of rotation around the axis are the coordinates. The respective coordinate values (θ, φ) are associated with the points on the spherical surface representing all directions from the image capturing point. Thus, the all directions are mapped on the spherical image.

### Stitching Position Detection

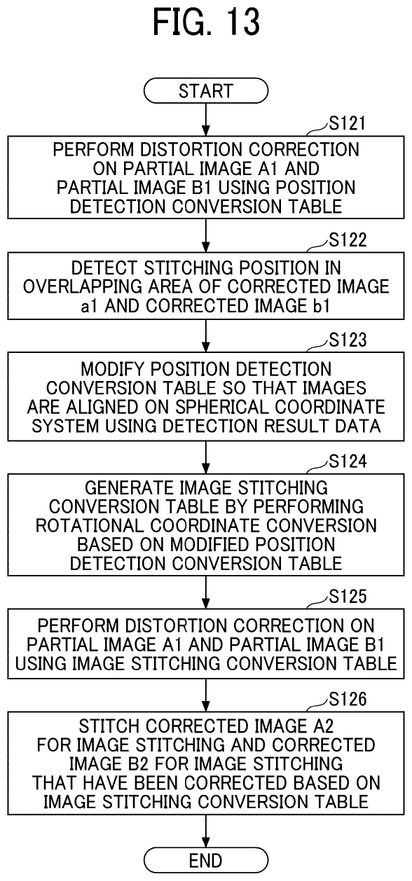

FIG. 13 is a flowchart of generating a spherical image by stitching images captured by two fisheye lenses.

The abnormality detection unit 16 performs distortion correction on the partial image A1 and the partial image B1 obtained by the imaging element 103a and the imaging element 103b, respectively, using a position detection conversion table (Step S121).

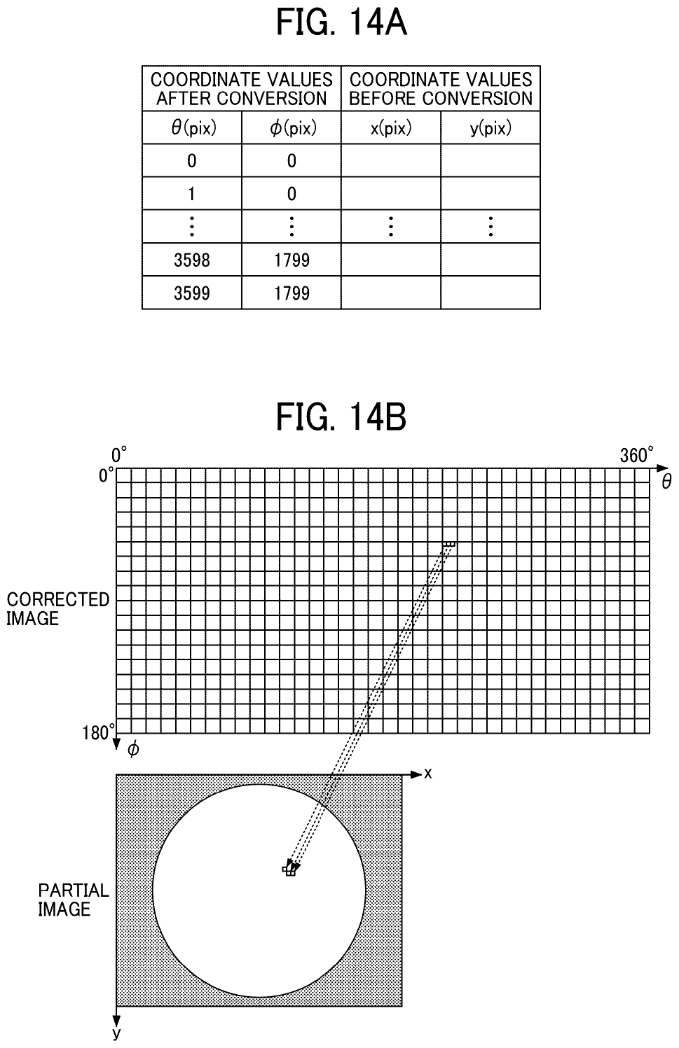

FIGS. 14A and 14B are diagrams illustrating a conversion table for converting a fisheye image into a spherical image. The conversion table defines a projection to an image represented by the spherical coordinate system based on a partial image represented by the plane coordinate system. As illustrated in FIGS. 14A and 14B, the conversion table holds, for each fisheye lens, information in which a coordinate value (θ, φ) of a post-correction image and a coordinate values (x, y) of a pre-correction partial image that is to be mapped on the coordinate value (θ, φ) are associated with each other, for all the coordinate values (θ, φ). In the example illustrated in FIGS. 14A and 14B, the angle of each of the pixels is one-tenths of a degree in both φ direction and θ direction, and the conversion table has information indicating correspondence relationship of 3600×1800 for each fisheye lens. The stitching position detection conversion table used for detecting a stitching position is calculated and tabulated after correcting distortion from an ideal lens model in, for example, a manufacture in advance.

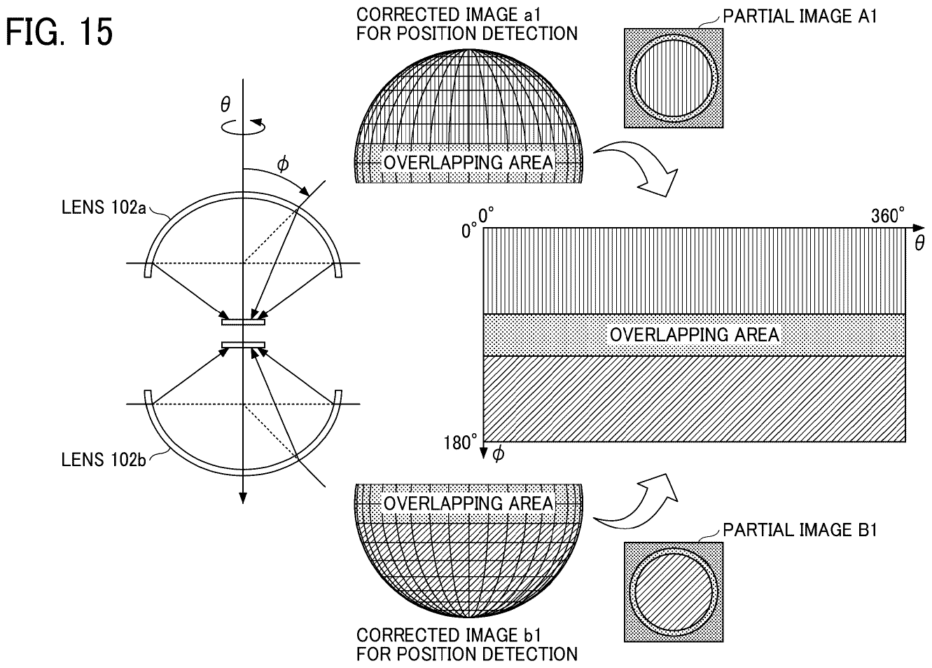

FIG. 15 is a diagram illustrating mapping of two partial images captured by two fisheye lenses to a spherical coordinate system in position detection. As a result of the processing by the position detection conversion table, the two partial images A1 and B1 captured by the fisheye lenses are developed onto a spherical image format as illustrated in FIG. 15. The partial image A1 captured by the fisheye lens 102a is typically mapped approximately the upper hemisphere of the full sphere, and the partial image B1 captured by a fisheye lens 102b is mapped to approximately the lower hemisphere of the full sphere.

Because the fisheye lens has a full angle of view greater than 180 degrees, each of a corrected image a1 for position detection (corrected image a1) expressed in a spherical format and a corrected image b1 for position detection (corrected image b1) expressed in a spherical format extends a hemisphere. As a result, when the corrected image a1 and the corrected image b1 are superimposed, an overlapping area in which the image capturing ranges overlap between the images is generated.

Thus, the corrected image a1 in which the distortion of the partial image A1 is corrected and the corrected image b1 in which the distortion of the partial image B1 is corrected are obtained.

The abnormality detection unit 16 or the abnormality detection unit 56 detects a stitching position for the images in the overlapping area of the corrected image a1 and of the corrected image b1 (Step S122).

A stitching position of the corrected image a1 and the corrected image b1 is detected by pattern matching processing based on the corrected images a1 and b1 converted by the conversion table for stitching position detection, and a stitching position detection result is generated. As illustrated in FIG. 14, the position detection conversion table according to the present embodiment is generated so that the optical axes of the two lens optical systems are projected onto the two poles of the spherical surface, and the overlapping area of the images is projected onto the vicinity of the equator of the spherical surface. In the spherical coordinate system, the distortion increases as the vertical angle φ approaches a pole of 0 degrees or 180 degrees, and the accuracy of the stitching position detection deteriorates. To cope with this, the above-described projection that can enhance the accuracy of stitching position detection is used. In the example of FIG. 14, the two partial images captured by the two fisheye lenses are mapped to a spherical coordinate system, but three or more fisheye lenses may be used.

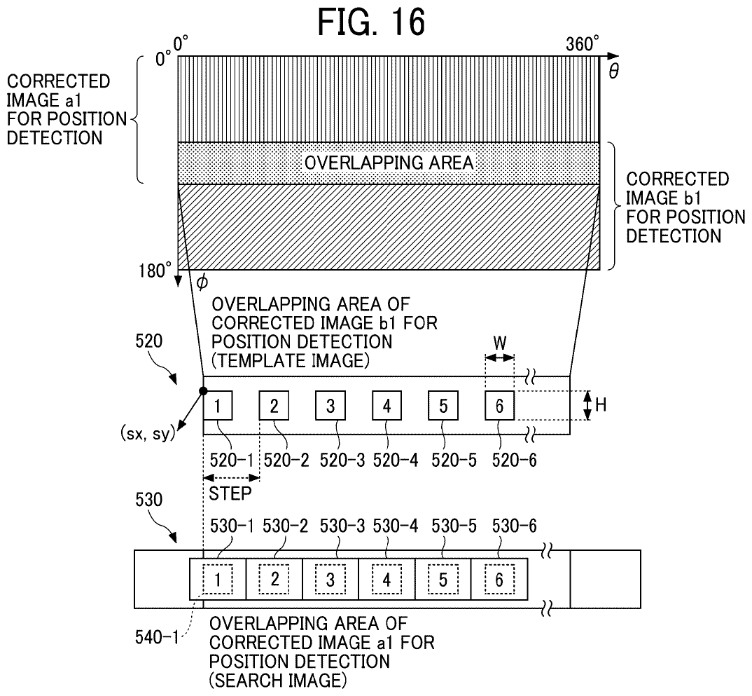

FIG. 16 is a diagram illustrating stitching position detection. A template image 520 is an image of a portion of the overlapping area in the corrected image b1, and a search image 530 is an image of a portion of the overlapping area in the corrected image a1. When a template image is generated with a specified size W and specified generation interval steps, multiple template images 520-1 to 520- #are generated as illustrated in FIG. 16.

A corresponding portion 540-1 on the search image 530 is searched for in a predetermined search range by template matching performed on the multiple generated template images 520-1 to 520- #. For each of the template images 520-1 to 520- #, an offset amount from the reference position that is a position where the matching score is the maximum is detected.

The abnormality detection unit 16 or the abnormality detection unit 56 receives the input of the corrected images a1 and b1 converted in Step S121, detects a stitching position of the input corrected images a1 and b1 by pattern matching, and generates detection result data.

The abnormality detection unit 16 or the abnormality detection unit 56 modifies the position detection conversion table so that the images are aligned on a spherical coordinate system using the detection result data generated in Step S122 (Step S123).

Since the offset amount is obtained for each coordinate value of the spherical image format by the stitching position detection in Step S122, the correction is performed so that (x, y) associated with (θ+Δθ, φ+Δφ) before the correction is associated with the input coordinate value (θ, φ) in a detection distortion correction table Ta used for the distortion correction of the partial image A1, in Step S123. The correspondence for a detection distortion correction table Tb used for the distortion correction of the partial image B1 does not need to be changed.

The abnormality detection unit 16 or the abnormality detection unit 56 generates an image stitching conversion table by performing rotational coordinate conversion based on the position detection conversion table modified in Step S123 (Step S124).

The abnormality detection unit 16 or the abnormality detection unit 56 performs distortion correction on the original partial image A1 and the original partial image B1 using the image stitching conversion table generated in Step S124, and obtains a corrected image A2 for image stitching and a corrected image B2 for image stitching (Step S125).

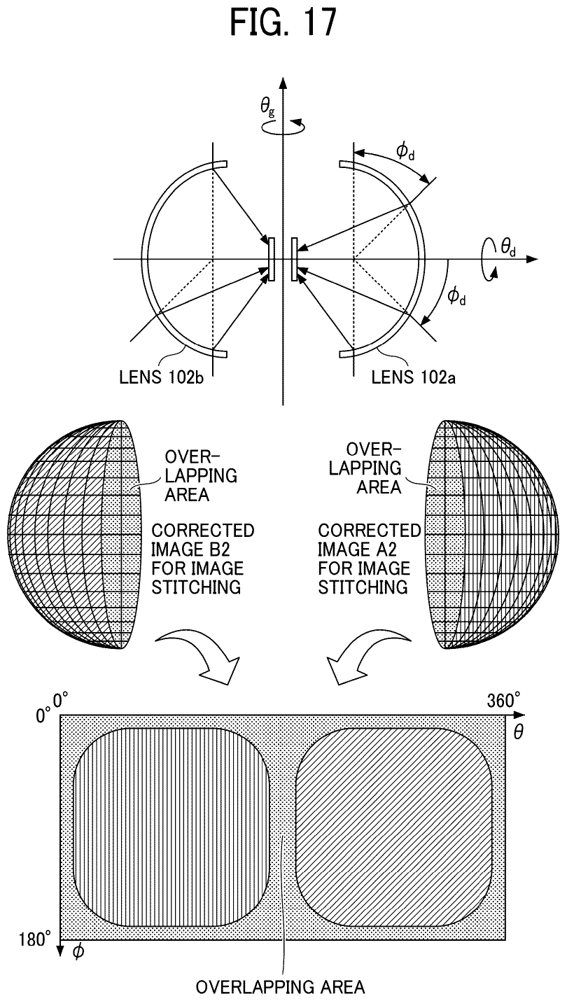

FIG. 17 is a diagram illustrating mapping of two partial images captured by two fisheye lenses to a spherical coordinate system in image stitching. By the rotational coordinate conversion, the definition of the coordinate axes of the horizontal angle and the vertical angle with the optical axis of one lens optical system as an axis as illustrated in FIG. 15 is converted into the definition of the horizontal angle and the vertical angle with an axis perpendicular to the optical axis as a reference as illustrated in FIG. 17. As a result, the two partial images A1 and B1 captured by the fisheye lens are developed onto a spherical image format as illustrated in FIG. 17. Typically, the corrected image A2 for image stitching that is captured via the fisheye lens 102a and is subjected to distortion correction is mapped to approximately the left hemisphere of the full sphere, and the corrected image B2 for image stitching that is captured via the fisheye lens 102b and is subjected to distortion correction is mapped to approximately the right hemisphere of the full sphere. FIG. 17 illustrates mapping of two partial images captured by two fisheye lenses onto a spherical coordinate system, but in the case of three or more fisheye lenses, three or more partial images are stitched to generate a spherical image.

The abnormality detection unit 16 or the abnormality detection unit 56 stitches the corrected image A2 for image stitching and the corrected image B2 for image stitching (Step S126).

In this stitching, for example, blending is performed on the overlapping area where the images overlap each other, and pixel values in an area where one of the images is present, the pixel values of the image are directly adopted. As a result of the stitching, a full view spherical image is generated from the two partial images captured by the fisheye lens.

### Abnormality Detection

In the image capturing device 10, various abnormalities that interfere with the image capturing occur. When the image capturing device 10 does not operate due to the occurrence of an abnormality and fails to perform imaging, the user may notice the abnormality of the image capturing device 10. However, when imaging can be performed even if there is an abnormality, the user may perform imaging without noticing the abnormality. Further, various abnormalities occur in the image capturing device 10, and it is difficult for the user to notice each abnormality. If the user continues to operate the image capturing device 10 for imaging without noticing the abnormality, a problem may occur in the captured still image or moving image, and the imaging data may not be usable. This can make the user to operate the image capturing device 10 for imaging again under the same conditions. The damage is incalculable when a large amount of imaging data has been already obtained or when the image capturing device 10 fails to perform imaging again under the same conditions.

Abnormality detection in the image capturing device 10 is described below.

### Types of Abnormalities

The abnormalities occurring in the image capturing device 10 are diverse, and include, as lens-related abnormalities, one-sided blur, lens scratches, coating peeling, peripheral illumination, dust on the image sensor, and foreign matter on the lens.

One-sided blur refers to a condition where the resolution is reduced when compared between one or more lenses. Typically, the resolution tends to be lower in the peripheral portion of a wide-angle lens (fisheye lens) than in the central portion of the lens, but the degree of the decrease is the same in the peripheral portion of the lens. When the lens condition changes due to impacts during transportation after factory shipment or during use, the resolution in a part of the peripheral portion of the lens may decrease more than expected. Further, when multiple lenses are present, it is considered that the resolution of a specific lens is reduced when compared between the lenses.

Lens scratch indicates that the lens is damaged when the image capturing device 10 is dropped, tilted, or hit against an object. In particular, when the lens has a protruding structure or when multiple lenses are present, the lens may be damaged unintentionally. When the lens scratch occurs, partial imaging defects, blur, smearing, flare, ghosting, etc., may occur due to lens scratches at the same position in a captured image every time the image capturing device 10 performs imaging.

Coating peeling is a phenomenon in which a thin film formed on the lens surface for the purpose of enhancing and protecting the lens performance peels off, and occurs due to, for example, contact with an object, or aging deterioration. When the coating peeling occurs, blurring, bleeding, flare, ghost, etc., may occur in a captured image. Peripheral illumination refers to the amount of light in the peripheral area relative to the central portion of the lens. The amount of light incident on the peripheral portion is reduced compared to the central portion of the lens. Accordingly, an image area corresponding to the peripheral portion of the lens becomes dark, which typically occurs in a wide-angle lens (e.g., fisheye lens). This phenomenon is reduced by performing correction by image processing. When the lens condition changes from the factory shipment, the intended correction is not applied, and this can cause the phenomenon to worsen.

Dust on the image sensor indicates a state in which dust is attached to the surfaces of an imaging element (103a or 103b). The image capturing device 10 is sealed with its exterior fastened by screws or similar methods, but dust may enter through a gap or dust generated inside the image capturing device 10 may be attached to or adhered to the surface of an image sensor (imaging element). When dust attached to or adheres to the surface of the image sensor, the foreign matter is unintentionally captured at the same position in a captured image every time the image capturing device 10 performs imaging. Even in the imaging setting of the image capturing device 10, dust is conspicuous (large aperture value) in some cases and is inconspicuous (small aperture value) in other cases.

Foreign matter on the lens indicates a state in which foreign matter such as dirt, dust, fingerprints, or water droplets attaches to or adheres to the lens surface. In particular, when the lens has a protruding structure or when multiple lenses are present, the lens is frequently in contact with foreign matter, and foreign matter may adhere to it without notice. When foreign matter is attached to or adheres to the surface of the image sensor, the foreign matter is unintentionally captured at the same position in a captured image every time the image capturing device 10 performs imaging.

In the present embodiment, an example of a lens-related abnormality is described, but the present disclosure is not limited thereto, and can be applied to abnormalities that typically occur in image capturing devices.

### First Abnormality Detection

### Abnormality Detection Sequence

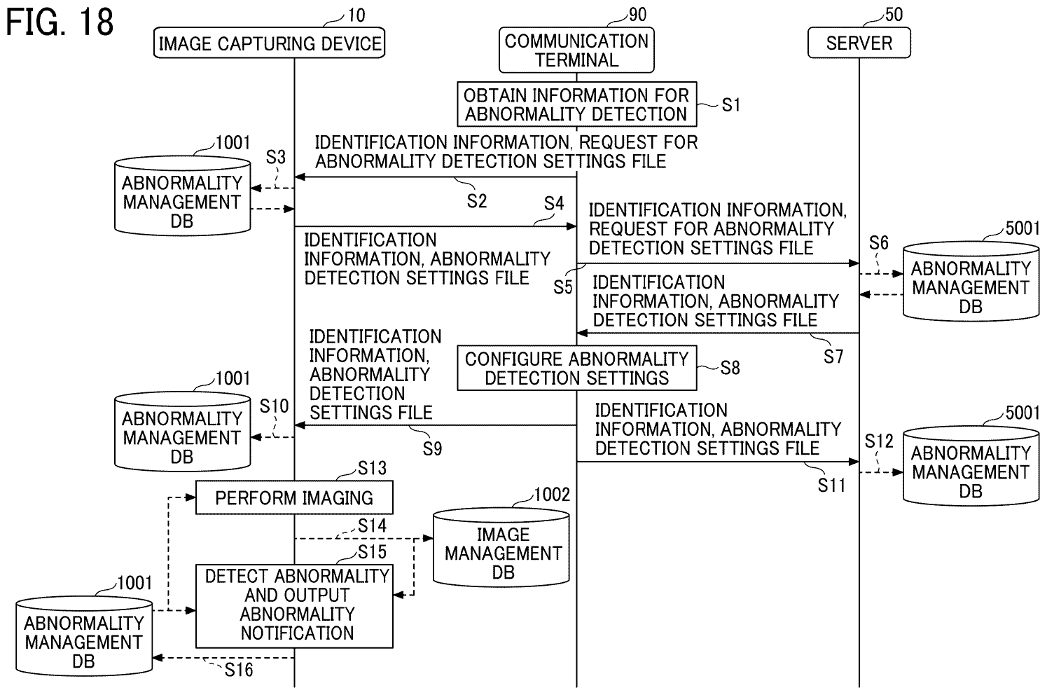

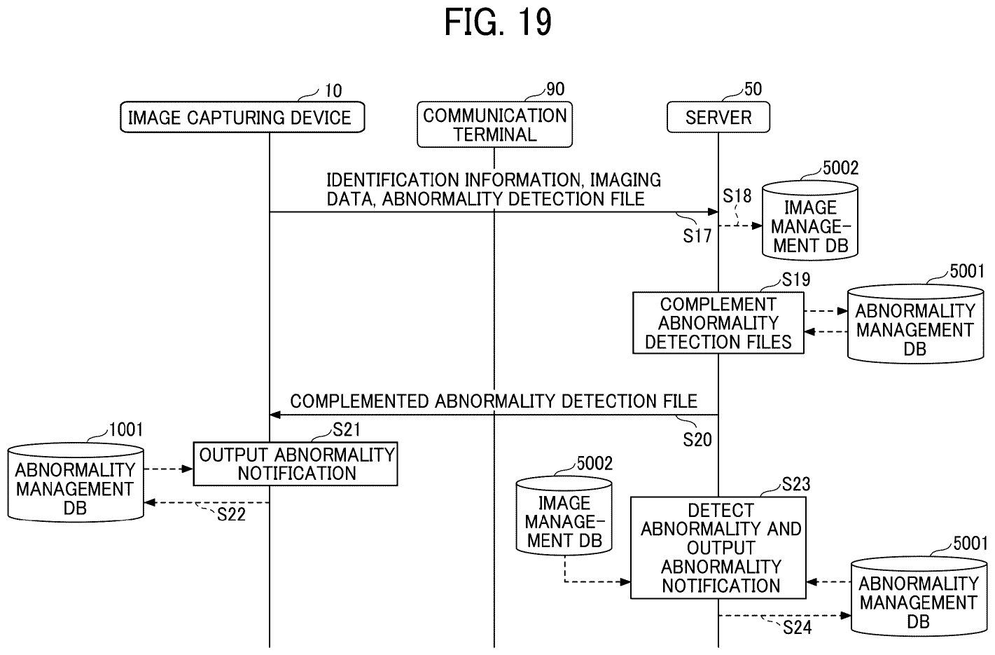

FIGS. 18 and 19 are sequence diagrams illustrating a process of first abnormality detection. In FIGS. 18 and 19, abnormality detection is set up with the communication terminal 90, and abnormality detection is performed with the image capturing device 10 and the server 50.

The reception unit 92 of the communication terminal 90 receives a user operation to enter a mode for setting up abnormality detection. Then, the reception unit 92 of the communication terminal 90 receives information such as identification information (user ID, model ID, Twin ID, etc.) input by the user (Step S1). The transmission/reception unit 91 of the communication terminal 90 transmits, to the image capturing device 10, the identification information and a request for the abnormality detection settings file of the image capturing device 10, and the transmission/reception unit 11 of the image capturing device 10 receives the identification information and the request for an abnormality detection settings file of the image capturing device 10 transmitted from the communication terminal 90 (Step S2). Based on the identification information and the request for the abnormality detection settings file of the image capturing device 10 received in Step S2, the storing/reading unit 19 searches the abnormality management DB 1001 and reads the abnormality detection settings file corresponding to the identification information (Step S3).

The abnormality detection settings file that holds setting information for abnormality detection, and the details of the abnormality detection settings file are described below.

### Abnormality Detection Settings File

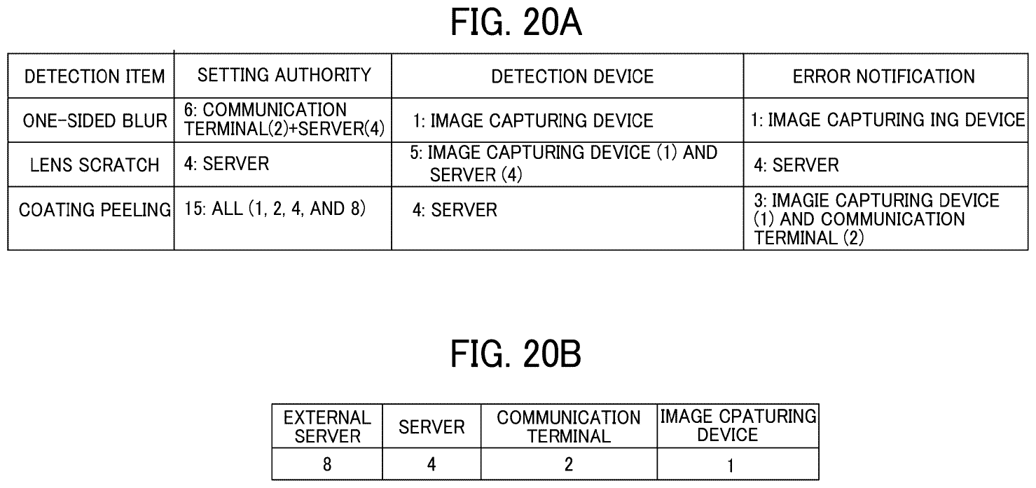

FIGS. 20A and 20B are diagrams each illustrating an example of an abnormality detection settings file. FIG. 20A illustrates setting items and configuration details of the abnormality detection settings file. Each device (including an apparatus, a terminal, and a server) stores an abnormality detection settings file in the device. The abnormality detection settings file illustrated in FIG. 20A is present for each different image capturing device. The setting items include detection item, setting authority, detection device, and error notification for each image capturing device.

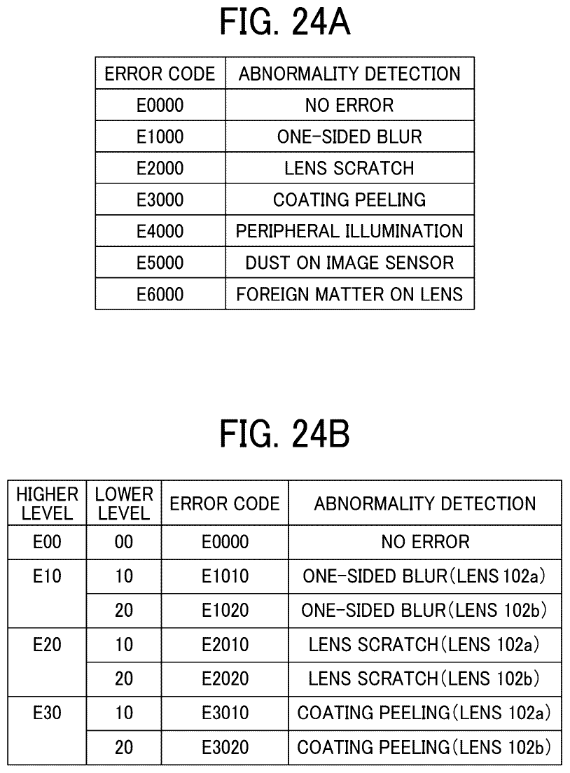

The detection item includes abnormalities to be detected, and includes, as lens-related detection items, one-sided blur, lens scratch, coating peeling, peripheral illumination, dust on the image sensor, and foreign matter on the lens. With the detection item, abnormalities to be detected is set. The abnormalities to be detected is defined (prepared) in advance (see FIG. 24).

The setting authority indicates authority to set up abnormality detection and to change the abnormality detection settings. For example, in the case of “COMMUNICATION TERMINAL AND SERVER”, the settings (detection device, error notification) for “ONE-SIDED BLUR” in an abnormality detection settings file can be changed with the communication terminal 90 and the server 50, but the settings for “ONE-SIDED BLUR” in the abnormality detection settings file is not changeable with the image capturing device 10 or the external server 70.

The detection device indicates a device that performs abnormality detection.

The error notification indicates an error notification destination when an abnormality is detected.

In the example of FIG. 20A, the items of setting authority, detection device, and error notification are set by selecting one or more devices from among the image capturing device 10, the communication terminal 90, the server 50, and the external server 70. For example, as illustrated in FIG. 20B, each item may be defined by a number, and the combination may be set by the total of the numbers (1 (image capturing device)+4 (server)=5 (image capturing device+server)). In the example of FIG. 20A, when the detection item is one-sided blur, the authority to set and change the settings for the abnormality detection granted when accessed by the image capturing device and the server, and the imaging device detects an abnormality and the error notification is provided to the image capturing device.

In the case of “IMAGE CAPTURING DEVICE AND SERVER”, the image capturing device 10 and the server 50 perform cooperative processing. Specifically, the image capturing device 10 performs abnormality detection (“Basic” detection or first abnormality detection), and the server 50 performs further abnormality detection that is different from the abnormality detection performed by the image capturing device 10 (“detailed” detection or second abnormality detection), thereby performing abnormality detection in cooperation. For example, the image capturing device 10 at a local site detects an abnormality by comparing the hemispherical image data illustrated in FIGS. 2A and 2B before generating the captured image illustrated in FIG. 2C and transmitting the captured image to the server 50 as imaging data. Then, the server 50 continues abnormality detection using the imaging data. In order to reduce the amount of heat generated by the image capturing device 10 by reducing the processing load of the image capturing device 10, the server 50 may perform the first abnormality detection and the second abnormality detection by combining the hemispherical image data illustrated in FIGS. 2A and 2B to create a captured image.

An abnormality notification setting file is to be stored in association with identification information (user ID, model ID, Twin ID, etc.). Accordingly, the identification information may be used as the file name of the abnormality notification setting file, or the identification information may be recorded in the file.

The data may be held in a JavaScript Object Notation (JSON) format or a Comma Separated Values (CSV) format, which are known data formats, or may be held in a binary format.

When the abnormality detection settings file is not present in the abnormality management DB 1001, an abnormality detection settings file corresponding to the identification information used in the search is created and stored in the abnormality management DB 1001. In this case, the configuration details of the abnormality detection settings file are set to default settings defined in advance.

The transmission/reception unit 11 of the image capturing device 10 transmits the identification information received in Step S2 and the abnormality detection settings file of the image capturing device 10 to the communication terminal 90, and the transmission/reception unit 91 of the communication terminal 90 receives the identification information and the abnormality detection settings file of the image capturing device 10 transmitted from the image capturing device 10 (Step S4).

The transmission/reception unit 91 of the communication terminal 90 transmits the identification information and a request for the abnormality detection settings file of the server 50 to the server 50, and the transmission/reception unit 51 of the server 50 receives the identification information and the request for the abnormality detection settings file of the server 50 transmitted from the communication terminal 90 (Step S5).

Based on the identification information and the request for the abnormality detection settings file of the server 50 received in Step S5, the storing/reading unit 59 searches the abnormality management DB 5001 and reads the abnormality detection settings file corresponding to the identification information (Step S6).

When the abnormality detection settings file is not present in the abnormality management DB 5001, the abnormality detection settings file corresponding to the identification information used in the search is created and stored in the abnormality management DB 5001. In this case, the configuration details of the abnormality detection settings file are set to predetermined default settings.

The transmission/reception unit 51 of the server 50 transmits the identification information received in Step S2 and the abnormality detection settings file of the server 50 to the communication terminal 90, and the transmission/reception unit 91 of the communication terminal 90 receives the abnormality detection settings file of the server 50 transmitted from the server 50 (Step S7).

### Abnormality Detection Settings Screen

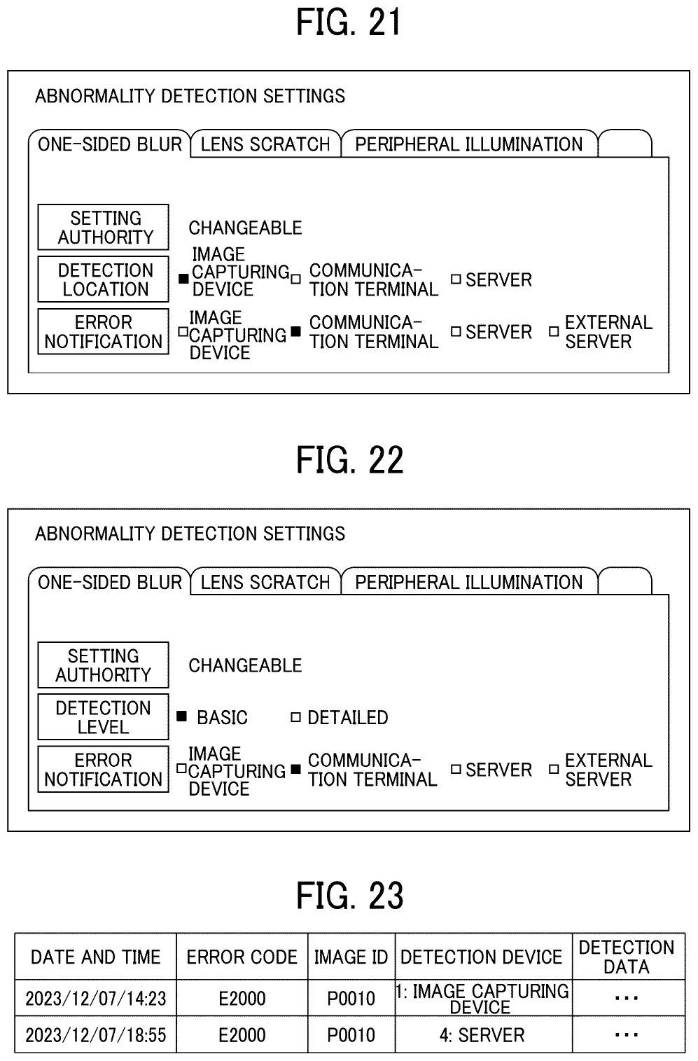

FIG. 21 is a diagram illustrating an example of an abnormality detection settings screen. The image capturing device 10 displays the screen on the LCD 122, and the communication terminal 90 displays the screen on the display 906.

The items displayed on the abnormality detection settings screen match the contents of the abnormality detection settings file. The abnormality detection settings file received from the image capturing device 10 in Step S4 and the abnormality detection settings file received from the server 50 in Step S7 are compared, and when there is a difference, the priorities of the settings are determined in advance (for example, server>image capturing device), and the abnormality detection settings file with the higher priorities is used. Selection information of the abnormality detection settings screen is displayed based on the abnormality detection settings file.

In FIG. 21, the display for the item of setting authority varies depending on whether the device displaying the abnormality detection settings screen has the authority to set and change the settings. If the authority to change the settings is granted, “CHANGEABLE” is displayed, if not, “NOT CHANGEABLE” is displayed. When the setting authority indicates “NOT CHANGEABLE”, the option is unchangeable.

### Detection Device

For detection devices, it is preferable to define in advance the devices that can perform detection for each detection item, as there may be restrictions on the devices that can perform detection depending on the detection item, as well as optimal devices (detection locations) or methods. It is also preferable to allow the user to select the detection device from among the detection devices that can perform the detection. In this case, the detection devices to be displayed varies depending on the detection item. The detection device includes the image capturing device 10, the communication terminal 90, and the server 50. The detection with the image capturing device 10 is suitable for processing that can only be implemented in the processing steps of the image capturing device 10, processing that can be performed easily, and processing requiring urgency.

The detection with the communication terminal 90 is suitable for processing that is not implemented by the image capturing device 10 in a way that mediates between the image capturing device 10 and the server 50 or processing that utilizes a function of the communication terminal 90. The detection with the server 50 is suitable for processing that takes time with the image capturing device 10 or the communication terminal 90 (high-precision processing even in the same or similar processing), or complicated processing that is not implemented by the resources of the image capturing device 10 or the communication terminal 90.

Further, there is a case in which the image capturing device 10 performs basic abnormality detection and the server 50 performs detailed abnormality detection. In addition, the image capturing device 10 may detect an abnormality based on the result of abnormality detection by the server 50 to increase the detection accuracy. Therefore, more than one detection device may be selected, or multiple levels may be prepared as detection levels instead of the detection devices as illustrated in FIG. 22. For example, the detection level such as “BASIC” and “DETAILED” and the number of times of detection may be set and fixed in advance so that abnormality detection is performed at one location for “BASIC” and abnormality detection is performed by multiple devices for “DETAILED”. In this case, for example, when “BASIC” is selected, abnormality detection by a single device (for example, the server 50) is automatically set, and when “DETAILED” is selected, abnormality detection by cooperation of multiple devices (for example, the image capturing device 10 and the server 50) is automatically set.

### Error Notification

With the item of error notification, an error notification destination for the occurrence of abnormality detection is set. In FIG. 21, there are options of the image capturing device 10, the communication terminal 90, the server 50, and the external server 70. When an abnormality is detected, the error information is displayed on the set error notification destination. For example, the image capturing device 10 displays an error on the LCD 122, the communication terminal 90 displays an error on the display 906, and the server 50 displays an error on the display 506. Further, in FIG. 21, the device is set as the error notification destination and the error display is performed, but the present disclosure is not limited to this. Several error notification methods may be provided as options. For example, when an abnormality occurs, the error notification may be implemented by sending an e-mail to an address registered in advance or by reporting the abnormality to a specific phone number via electronic voice.

User selection is performed for setting each item for abnormality detection on the abnormality detection settings screen, and the reception unit 92 receives information on the settings and creates an abnormality detection settings file common to the image capturing device 10 and the server 50 (Step S8).

The transmission/reception unit 91 transmits the identification information and the abnormality detection settings file created in Step S8 to the image capturing device 10, and the transmission/reception unit 11 of the image capturing device 10 receives the identification information and the abnormality detection settings file transmitted from the communication terminal 90 (Step S9). The storing/reading unit 19 stores the identification information and the abnormality detection settings file received in Step S9 in the abnormality management DB 1001 in association with each other (Step S10).

Similarly, the transmission/reception unit 91 transmits the identification information and the abnormality detection settings file created in Step S8 to the server 50, and the transmission/reception unit 51 of the server 50 receives the identification information and the abnormality detection settings file transmitted from the communication terminal 90 (Step S11). The storing/reading unit 59 stores the identification information received in Step S11 and the abnormality detection settings file in the abnormality management DB 5001 in association with each other (Step S12).

### Imaging and Abnormality Detection in Image Capturing Device

The imaging control unit 13 reads the abnormality detection settings from the abnormality management DB 1001 by the storing/reading unit 19 using the identification information as a search key and captures a still image or a moving image by the still image capturing unit 15 or the moving image capturing unit 14, in response to an imaging instruction given from the imaging control unit 13 according to a user operation (step S13). The storing/reading unit 19 stores the captured still image or moving image in the image management DB 1002 in association with the image ID (Step S14).

The abnormality detection unit 16 performs abnormality detection and outputs (displays) a notification indicating that an abnormality is detected, performed with the image capturing device in accordance with the abnormality detection settings, in the image of the imaging data obtained in Step S13 (Step S15). The storing/reading unit 19 stores information regarding the abnormality detected by the abnormality detection unit 16 in the abnormality management DB 1001 as an abnormality management file (Step S16). The abnormality detection performed in Step S15 may be performed on the imaging data stored in the image management DB 1002, or may be performed on the intermediate data in the image capturing sequence in Step S13.

### Abnormality Management File

FIG. 23 is a diagram illustrating an example of an abnormality management file. In the abnormality management file, information items of date and time, error code, image ID, detection device, and detection data are recorded. Each of the data items is described below.

The data item of date and time indicates a date and time when an abnormality is detected.

The data item of error code indicates a recorded abnormality detection result. Error codes are defined in advance for abnormality detection items, and an error code corresponding to a result obtained by abnormality detection is recorded.

FIGS. 24A and 24B are diagrams each illustrating an example of error codes for abnormality detection items.

FIG. 24A is an example in which an error code is defined for each abnormality detection item. The abnormality detection items include one-sided blur, lens scratch, coating peeling, peripheral illumination, dust on the image sensor, and foreign matter on the lens. When one-sided blur is detected in performing the abnormality detection for the item, the error code is E1000. When a lens scratch is detected in the abnormality detection for the item, the error code is E2000. As described above, the error codes are pre-defined for the abnormality detection items. An error code (E0000) is also defined for the case where no abnormality is detected.

The error codes illustrated in FIG. 24A may be used, or the error codes illustrated in FIG. 24B may be used. In FIG. 24B, the error codes are defied in more detail than that in FIG. 24A. The error codes are divided into a higher level part and a lower level part, the higher level part indicates an abnormality detection item, and the lower level part defines more detailed contents in the abnormality detection item. For example, in the case of the error code E1010, a higher level E10 indicates one-sided blur detection, and a lower level 10 indicates the lens 102a, thereby indicating that the one-sided blur is detected on the lens 102a.

The data item of image ID indicates image information used in performing abnormality detection. When the image information is not used, the column may be blank.

The data item of detection device indicates a detection device performing abnormality detection. The abnormality detection is performed by a device set in an abnormality detection settings file, and the device performing abnormality detection is recorded. The detection device may be represented by numerals as defined in FIG. 20B, and a combination of numerals may be recorded. Since detection may be performed at a plurality of positions depending on the detection item, the result of detection at each position may be recorded. In the example of FIG. 23, a lens scratch (error code E2000) is detected with an image having an image ID P0010 by the image capturing device and the server the image.

The data item of detection data indicates detection data obtained by calculation in performing abnormality detection.

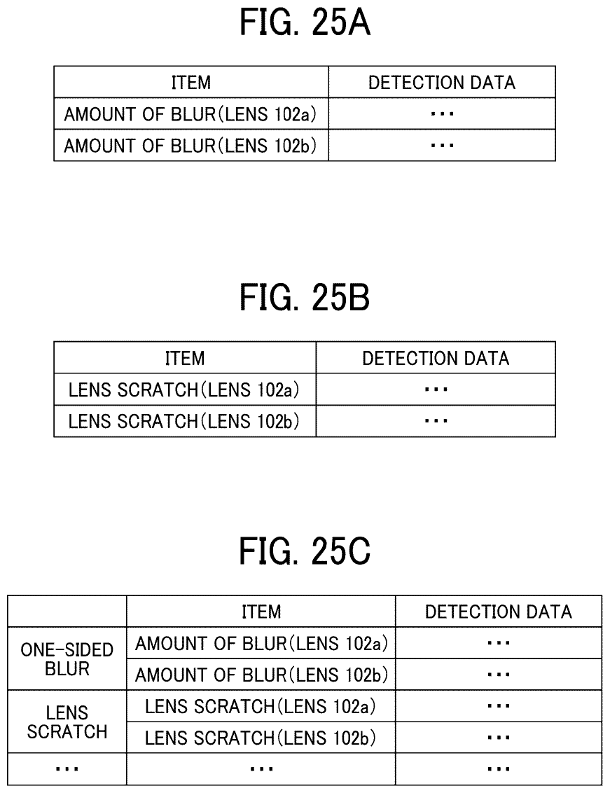

FIGS. 25A, 25B, and 25C are diagrams each illustrating a recording format for detection data. FIG. 25A indicates a recording format for detection data output for one-sided blur detection. For example, the amount of blur of each lens is recorded as detection data. FIG. 25B indicates a recording format for detection data output for lens scratch detection. For example, the determination level of a lens scratch of each lens is recorded as detection data. In FIG. 25C, the recording formats as illustrated in FIGS. 25A and 25B are combined, and detection data obtained by abnormality detection for the other abnormality detection items, such as coating peeling, peripheral illumination, dust on an image sensor, and foreign matte on a lens, are also included.

Since the calculated detection data varies depending on the abnormality detection item, the recording format may be changed for each abnormality detection item, or a recording format covering all abnormality detection items may be used so that the detection data may be recorded in the portion of the abnormality detection item.

The abnormality detection settings file and the abnormality management file in each of the abnormality management DB 1001 of the image capturing device 10 and the abnormality management DB 5001 of the server 50 may be stored as separate files, or stored as files having the same identification information in a single file.

### Error Flag

Further, one error flag can be set in the abnormality management file, separately from the above. The error flag is a flag indicating whether an abnormality has been detected, separately from the individual abnormality detection results. This allows a user to recognize easily whether an abnormality has occurred in the image capturing device 10 by checking the error flag without checking the individual abnormality detection results. When an abnormality is detected, an error flag is set to ON (for example, set to (expressed by) “1”) in the abnormality management file. If another abnormality is detected while the error flag is already “ON”, the error flag is kept as “ON”. When all the abnormalities are resolved (for example, replacement of parts or units, maintenance), the error flag is set to OFF (for example, set to (expressed by) “0”). When the error flag is ON, an error notification may be performed or the control of the image capturing device may be modified. A method to set the error flag to OFF is not disclosed to general users, but is disclosed to specific members, such as the manufacturer and support service. When an abnormality is detected, an inquiry can be made to the specific members, and the abnormality can be resolved correctly. A method to set the error flag to OFF is not disclosed to general users, but is disclosed to specific members, such as the manufacturer and support service. When an abnormality is detected, an inquiry can be made to the specific members, and the abnormality can be resolved correctly. By performing such control, an abnormality that is continuously occurring can be detected.

Abnormality Detection with Image Capturing Device 10 One-Sided Blur Detection

As an example of abnormality detection by the image capturing device 10 in Step S15, one-sided blur detection is described below. As described above, one-sided blur refers to a condition where the resolution is reduced when compared between one or more lenses. In the present embodiment, a method of detecting a decrease in resolution by comparing multiple lenses is described. The image capturing device 10 that is provided with the two fisheye lenses (102a and 102b) detects a stitching position and stitches two partial images captured by the two fisheye lenses by using an overlapping area where image capturing ranges overlap between images captured by the two fisheye lenses as illustrated in FIG. 16. In the overlapping area, the same subject is captured, and thus, by comparing the images at the position matched by the template matching for the stitching position detection, the side where the blur occurs in the two fisheye lenses can be detected. For example, in FIG. 16, the multiple template images (502-1 to 502- #) are generated in the overlapping area of the corrected image b1 for position detection, and the stitching position is detected by template matching using the overlapping area of the corrected image a1 for position detection as the search image, and an area having the same size as the template image is extracted from the search image at the matched position.

The variance value of luminance is calculated for each of the extracted images from the template image and the search image. Although the variance value affects the captured subject, a high variance value indicates that the subject is complex (contains features), while a low variance value indicates that the subject is simple (lacking features). Further, when blur occurs, a small portion of the subject is not captured due to the blur, and the variance value tends to decrease. By comparing the variance values of two images capturing the same subject, if there is a significant difference in the variance values, blur can be detected in the image with the smaller variance value. When multiple template images are used as in FIG. 16, the variance values are calculated in multiple areas. Thresholds are set for both the difference in variance and the number of detected abnormalities. When the difference in variance exceeds the threshold and the number of detected abnormalities is greater than or equal to the threshold, it can be determined that one-sided blur has occurred. The calculated variance value of each image may be recorded in the detection data (the amount of blur in FIG. 25A) of the abnormality management file in FIG. 23, and the variance value data of each area calculated for the multiple areas is recorded. When the one-sided blur is detected as an abnormality, the corresponding error code is recorded.

### Abnormality Management File Synchronization

As illustrated in FIG. 19, the transmission/reception unit 11 of the image capturing device 10 transmits the identification information, the imaging data (for example, a still image or a moving image), and the abnormality management file to the server 50 in response to a predetermined condition, and the transmission/reception unit 51 of the server 50 receives the identification information, the imaging data, and the abnormality management file transmitted from the image capturing device 10 (Step S17). The predetermined condition as a trigger is a condition where the image capturing device 10 is connectable to (can be synchronized with) the server 50 via the communication network 100. For example, the image capturing device 10 may be connected to the server 50 via the communication network 100 in cooperation with the communication terminal 90 (via the communication terminal 90), or the image capturing device 10 may be connected to the server 50 by being reconnected from a state in which the image capturing device 10 is not connectable to the communication network 100 due to disconnection from the communication network 100 by the user or a communication environment. When no abnormality is detected in Step S15, the absence of abnormality is recorded or no data is recorded in the abnormality management file.

The storing/reading unit 59 stores the imaging data (for example, the still image or the moving image) received in Step S17 in the image management DB 5002 in association with the identification information (Step S18).

The storing/reading unit 59 searches the abnormality management DB 5001 and reads the abnormality management file corresponding to the identification information received in Step S17, compares the abnormality management file of the image capturing device 10 received in Step S17 with the abnormality management file of the server 50 stored in the Step S24 in the process previously performed, and generates an abnormality management file obtained by complementing the two files, if there is a difference between the two files, to store the generated abnormality management file in the abnormality management DB 5001 (Step S19).

When the abnormality management files of the image capturing device 10 and the server 50 are different from each other and the complemented abnormality management file is generated in Step S19, the transmission/reception unit 51 transmits the identification information and the abnormality management file complemented (generated) in Step S19 to the image capturing device 10, and the transmission/reception unit 11 of the image capturing device 10 receives the identification information and the abnormality management file transmitted from the server 50 (Step S20).

The abnormality detection unit 16 checks the abnormality management file received in Step S20, and when an abnormality error code of an abnormality detected by the server 50 is recorded, the storing/reading unit 19 reads the abnormality detection settings that are configured in Step S8 and stored in the abnormality management DB 1001 in Step S10. When the error notification is set for the image capturing device, the LCD 122 of the image capturing device 10 outputs (displays) the abnormality detection information (the details of an error, an error code, etc.) as a notification (Step S21).

The storing/reading unit 19 stores the identification information received in Step S20 and the abnormality management file in the abnormality management DB 1001 in association with each other (Step S22).

Abnormality Detection with Server

When the abnormality detection settings read, by the storing/reading unit 59, from the abnormality management DB 5001 using the identification information as a search key indicates the detection device is set to the server, the abnormality detection unit 56 performs abnormality detection in the server on the captured image (for example, the still image or the moving image) that is received from the image capturing device 10 in Step S18 and stored in the image management DB 5002 (Step S23) and stores information obtained by the abnormality detection as an abnormality management file in the abnormality management DB 5001 (Step S24).

### Detection by Server 50

### Lens Scratch Detection

As an example of abnormality detection by the server 50 in Step S23, lens scratch (damage) detection is described below. As described above, lens scratch indicates that a lens is damaged when the image capturing device 10 is dropped, tilted, or hit against an object. When the lens scratch occurs, partial imaging defects, blur, smearing, flare, ghosting, etc., may occur due to lens scratches at the same position in a captured image every time the image capturing device 10 performs imaging.

In the present embodiment, a method of detecting a lens scratch using machine learning is described. The lens scratch has various symptoms depending on the position, size, shape, etc., of a scratch, and it is very difficult to determine the lens scratch from imaging data. When a scratch (the influence of the scratch) is large, the user may notice the scratch by viewing the lens or the imaging data and may inquire or request the manufacturer or the support service to repair the damaged lens. In this case, whether a lens scratch has occurred can be determine from the image capturing device 10 having a problem and the imaging data. Since the imaging data related to the lens scratches is accumulated in the manufacturer or the support service, the data is used as training data for machine learning to create an inference model. The image management DB 5002 of the server 50 stores the imaging data (still images, moving images, etc.) of the image capturing device 10 in association with the identification information (user IDs, model IDs, Twin ID, etc.). Accordingly, the imaging data of the image capturing device 10 for multiple images is available by a person having viewing access to it. The imaging data related to a lens scratch that is hardly noticed by the user is also included, and by using the imaging data for training, a higher-precision inference model can be created. Further, since new imaging date is added to the image management DB 5002 of the server 50 every day, the inference model can be periodically updated to the latest high-precision inference model through machine learning. The storing/reading unit 59 reads the imaging data corresponding to the identification information stored in the image management DB 5002, and an abnormality detection unit 56 detects the lens a lens scratch from the imaging data by using the inference model. As the detection data (lens scratch in FIG. 25B) of the abnormality management file in FIG. 23, an inference value inferred by the inference model may be recorded. When a lens scratch is detected as an abnormality, the corresponding error code is recorded. Machine learning can be used to learn and infer not only lens scratches, but also coating peel, dust on the imaging sensor, and foreign matter on the lens. By using image data with each specific issue as training data and adding it to the inference model, it becomes possible to classify and infer which type of abnormality has occurred in image data on which abnormality detection is performed (class classification).

Abnormality Detection with Cooperation between Image Capturing Device 10 and Server 50

### Lens Scratches

As an example of abnormality detection by the image capturing device 10 in Step S15 and the server 50 in Step S23 in cooperation with each other, lens scratch detection is described below. As described above, in the lens scratch detection by the server 50, the abnormality can be detected by creating the latest high-precision inference model and performing inference using the imaging data stored in the image management DB 5002 of the server 50. The image capturing device 10 in Step S15 can also detect a lens scratch using machine learning. The inference model is held in the image capturing device 10, the image capturing device 10 performs imaging (Step S13), and a lens scratch is detected by inferring from the imaging data stored in the image management DB 1002 (Step S14).

However, it is difficult for the image capturing device 10 and the server 50 to perform the same processing because the resources are different. It is desirable that the image capturing device 10 be light and simple in processing. Therefore, the machine learning method and inference model may differ from those used in server 50, and the inference model may not be frequently updated but instead be limited to updates timed with firmware updates of the image capturing device 10. The purpose of performing abnormality detection by the image capturing device 10 even in a simple manner is to quickly notify the user of the likelihood of an abnormality at the imaging timing, and even if the determination of abnormality detection is incorrect, the user can continue imaging after confirming the image capturing device 10. The detection device in the abnormality management file in FIG. 23 may be “image capturing device”, and an inference value inferred by the inference model may be recorded as the detection data (lens scratch in FIG. 25B).

In the case where multiple locations (devices) are set as the detection device in FIG. 20A, when an abnormality is detected at one location, another location also performs abnormality detection. For example, when the image capturing device 10 detects an abnormality, the server 50 also performs abnormality detection. The same detection method may be used by different detection devices, but the detection results will also be the same. Therefore, if a different detection method is available, it is better to use it. A method used in later detection is preferable if it provides higher accuracy.

Control Change upon Abnormality Detection

When an abnormality is detected, the control of the image capturing device 10 may be changed in addition to the error notification. For example, when an image is captured by the image capturing device 10 (Step S13) and stored in the image management DB 1002 (Step S14), the images captured by the fisheye lenses may be output and stored without being stitched by the image capturing device 10. This allows the user to recognize that something different from a usual situation has occurred by checking the recorded imaging data in which the images captured by the fisheye lenses are not stitched. Further, this allows the user to recognize from which imaging the abnormality has been detected, and detection that is supposed to be implemented by processing of the image capturing device 10 can be performed at a different place. Further, depending on the type of abnormality, the imaging data can be modified by image processing (correction is performable on the image of the imaging data), or the abnormality can be reduced. The settings may include information indicating whether an image is correctable, depending on the type of abnormality. The settings may include information indicating that an image is correctable according to the type of abnormality.

### Second Abnormality Detection

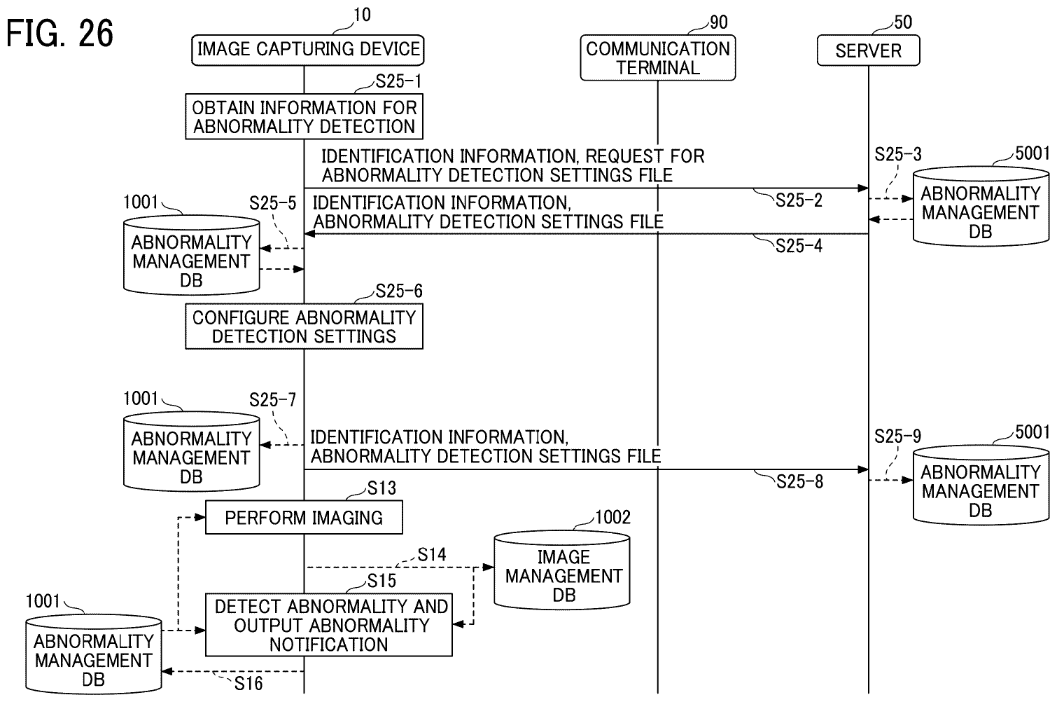

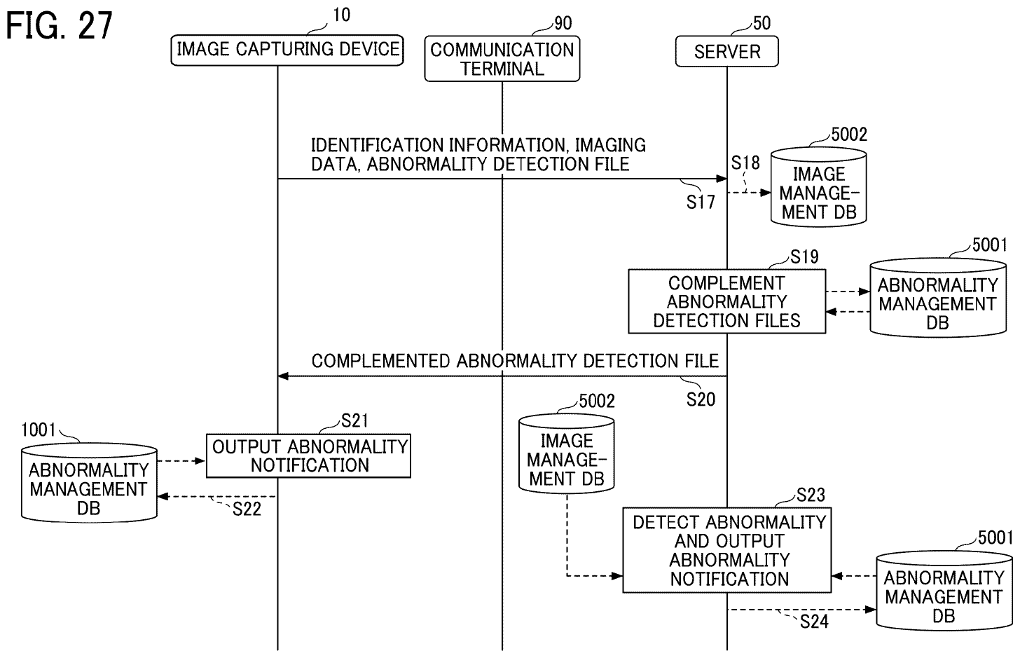

FIGS. 26 and 27 are sequence diagrams illustrating a process of second abnormality detection. In FIGS. 26 and 27, abnormality detection is set up with the image capturing device 10, and abnormality detection is performed with the image capturing device 10 and the server 50.

The operation reception unit 12 of the image capturing device 10 receives a user operation to enter a mode for setting up abnormality detection. Then, the operation reception unit 12 of the image capturing device 10 receives information such as identification information (user ID, model ID, Twin ID, etc.) input by the user (Step S25-1). The transmission/reception unit 11 of the image capturing device 10 transmits the identification information and a request for the abnormality detection settings file of the server 50 to the server 50, and the transmission/reception unit 51 of the server 50 receives the identification information and the request for the abnormality detection settings file of the server 50 transmitted from the image capturing device 10 (Step S25-2). Based on the identification information and the request for the abnormality detection settings file of the server 50 received in Step S25-2, the storing/reading unit 59 searches the abnormality management DB 5001 and reads the abnormality detection settings file corresponding to the identification information (Step S25-3).

When the abnormality detection settings file is not present in the abnormality management DB 5001, an abnormality detection settings file corresponding to the identification information used in the search is created and stored in the abnormality management DB 5001. In this case, the configuration details of the abnormality detection settings file are set to default settings defined in advance.

The transmission/reception unit 51 of the server 50 transmits the identification information received in Step S25-2 and the abnormality detection settings file of the server 50 to the image capturing device 10, and the transmission/reception unit 11 of the image capturing device 10 receives the identification information and the abnormality detection settings file of the server 50 transmitted from the server 50 (Step S25-4).

The storing/reading unit 19 searches the abnormality management DB 1001 and reads the abnormality detection settings file corresponding to the identification information (Step S25-5).

When the abnormality detection settings file is not present in the abnormality management DB 1001, an abnormality detection settings file corresponding to the identification information used in the search is created and stored in the abnormality management DB 1001. In this case, the configuration details of the abnormality detection settings file are set to default settings defined in advance.

User selection is performed for setting each item for abnormality detection on the abnormality detection settings screen in FIG. 21 displayed on the LCD 122, and the operation reception unit 12 receives information on the settings and creates an abnormality detection settings file common to the image capturing device 10 and the server 50 (Step S25-6).

The storing/reading unit 19 stores the identification information generated in Step S25-6 and the abnormality detection settings file in the abnormality management DB 1001 in association with each other (Step S25-7).

The transmission/reception unit 11 transmits the identification information and the abnormality detection settings file created in Step S25-6 to the server 50, and the transmission/reception unit 51 of the server 50 receives the identification information and the abnormality detection settings file transmitted from the image capturing device 10 (Step S25-8). The storing/reading unit 59 stores the identification information and the abnormality detection settings received in Step S25-8 in the abnormality management DB 5001 in association with each other (Step S25-9).

The processing after Step S13 is substantially the same as that in the first abnormality detection, and thus the description thereof is omitted.

### Third Abnormality Detection

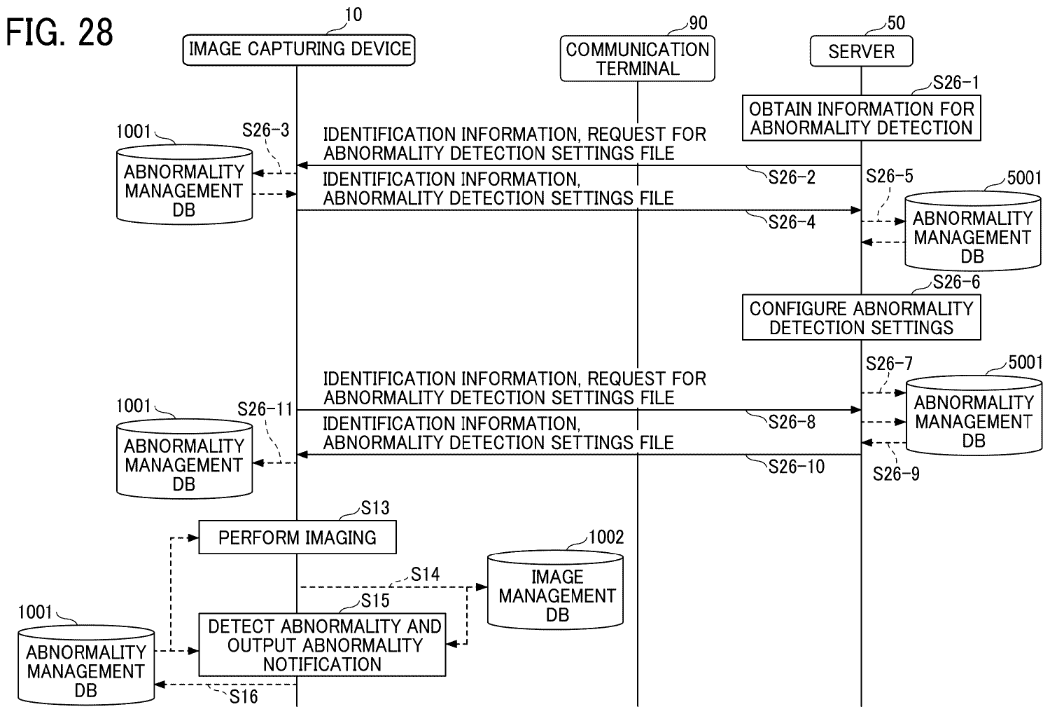

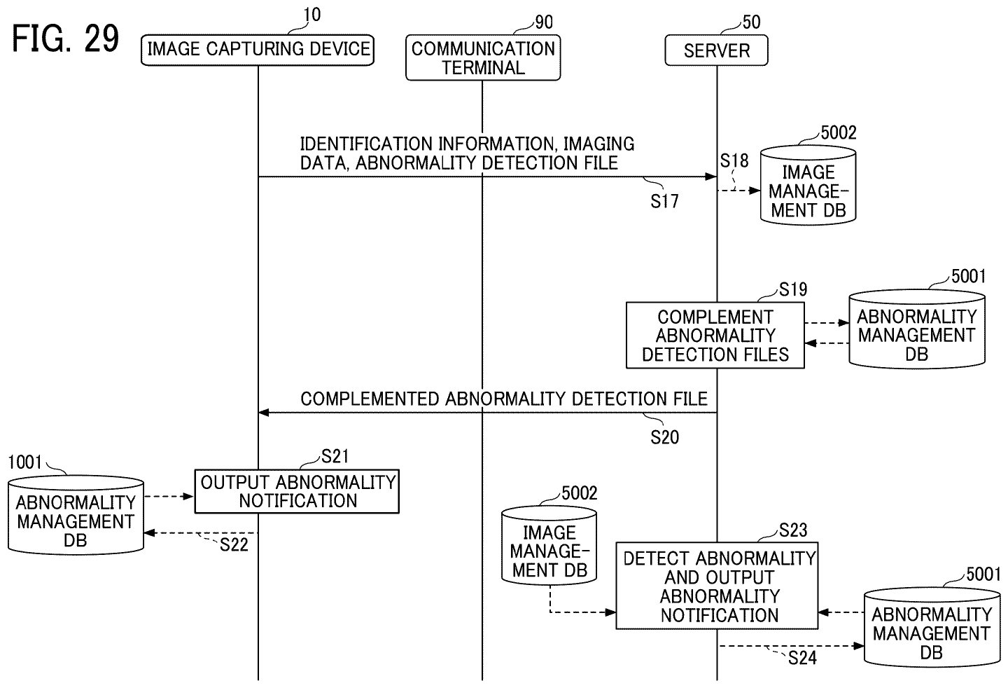

FIGS. 28 and 29 are sequence diagrams illustrating a process of third abnormality detection. In FIGS. 28 and 29, abnormality detection is set up with the server 50, and abnormality detection is performed with the image capturing device 10 and the server 50.

The reception unit 52 of the server 50 receives a user operation to enter a mode for setting up abnormality detection. Then, the reception unit 52 of the server 50 receives information such as identification information (user ID, model ID, Twin ID, etc.) input by the user (Step S26-1). The transmission/reception unit 51 of the server 50 transmits, to the image capturing device 10, the identification information and a request for the abnormality detection settings file of the image capturing device 10, and the transmission/reception unit 11 of the image capturing device 10 receives the identification information and the request for an abnormality detection settings file of the image capturing device 10 transmitted from the server 50 (Step S26-2). Based on the identification information and the request for the abnormality detection settings file of the image capturing device 10 received in Step S26-2, the storing/reading unit 19 searches the abnormality management DB 1001 and reads the abnormality detection settings file corresponding to the identification information (Step S26-3).

When the abnormality detection settings file is not present in the abnormality management DB 1001, an abnormality detection settings file corresponding to the identification information used in the search is created and stored in the abnormality management DB 1001. In this case, the configuration details of the abnormality detection settings file are set to default settings defined in advance.

The transmission/reception unit 11 of the image capturing device 10 transmits the identification information received in Step S26-2 and the abnormality detection settings file of the image capturing device 10 to the server 50, and the transmission/reception unit 51 of the server 50 receives the identification information and the abnormality detection settings file of the image capturing device 10 transmitted from the image capturing device 10 (Step S26-4). When the server 50 and the image capturing device 10 are disconnected due to a communication issue or the image capturing device 10 being turned off, the processing of Steps S26-2 to S26-4 is not performed (omitted.

The storing/reading unit 59 searches the abnormality management DB 5001 and reads the abnormality detection settings file corresponding to the identification information (Step S26-5).

When the abnormality detection settings file is not present in the abnormality management DB 5001, an abnormality detection settings file corresponding to the identification information used in the search is created and stored in the abnormality management DB 5001. In this case, the configuration details of the abnormality detection settings file are set to default settings defined in advance.

User selection is performed for setting each item for abnormality detection on the abnormality detection settings screen in FIG. 21 displayed on the display 506, and the reception unit 52 receives information on the settings and creates an abnormality detection settings file common to the image capturing device 10 and the server 50 (Step S26-6).

The storing/reading unit 19 stores the identification information generated in Step S26-6 and the abnormality detection settings file in the abnormality management DB 5001 in association with each other (Step S26-7).

Then, the transmission/reception unit 11 of the image capturing device 10 transmits the identification information and a request for the abnormality detection settings file of the server 50 to the server 50, and the transmission/reception unit 51 of the server 50 receives the identification information and the request for the abnormality detection settings file of the server 50 transmitted from the image capturing device 10 (Step S26-8). Based on the identification information and the request for the abnormality detection settings file of the server 50 received in Step S26-8, the storing/reading unit 59 searches the abnormality management DB 5001 and reads the abnormality detection settings file corresponding to the identification information (Step S26-9).

The transmission/reception unit 51 transmits the identification information and the abnormality detection settings file read in Step S26-9 to the image capturing device 10, and the transmission/reception unit 11 of the image capturing device 10 receives the identification information and the abnormality detection settings file transmitted from the server 50 (Step S26-10). The storing/reading unit 19 stores the identification information and the abnormality detection settings received in Step S26-10 in the abnormality management DB 1001 in association with each other (Step S26-11).

The reason why the image capturing device 10 requests the server 50 to transmit the abnormality detection settings file in Step S26-8 is to consider a case where the server 50 and the image capturing device 10 are (previously) disconnected due to a communication issue or the image capturing device 10 being turned off.

The processing after Step S13 is substantially the same as that in the first abnormality detection, and thus the description thereof is omitted.

### Fourth Abnormality Detection

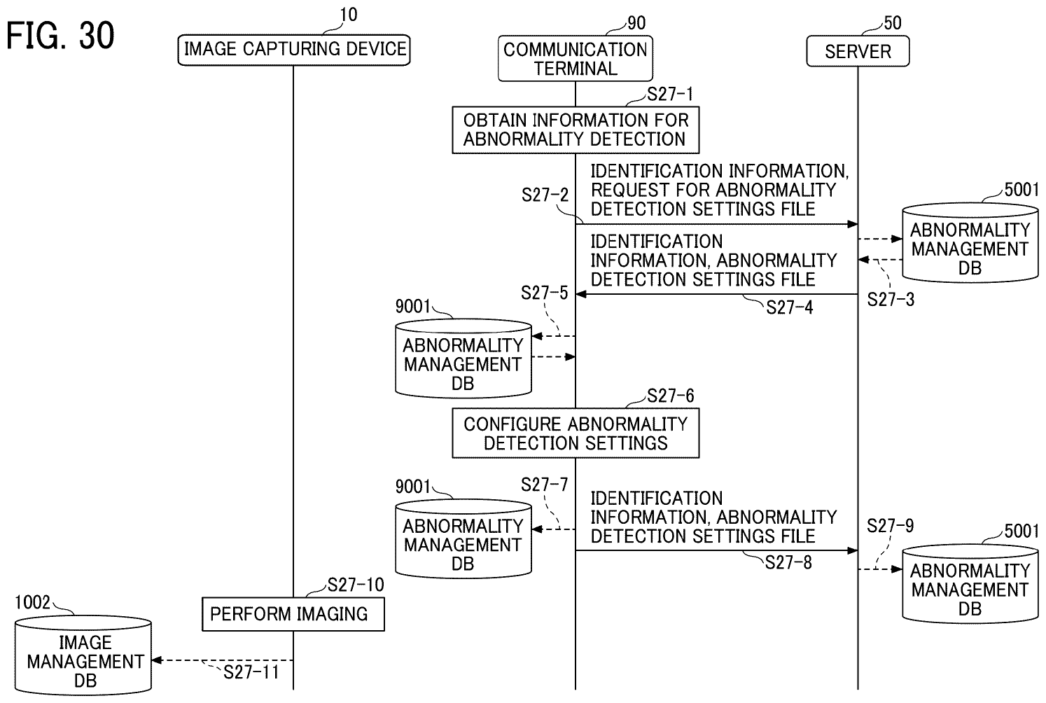

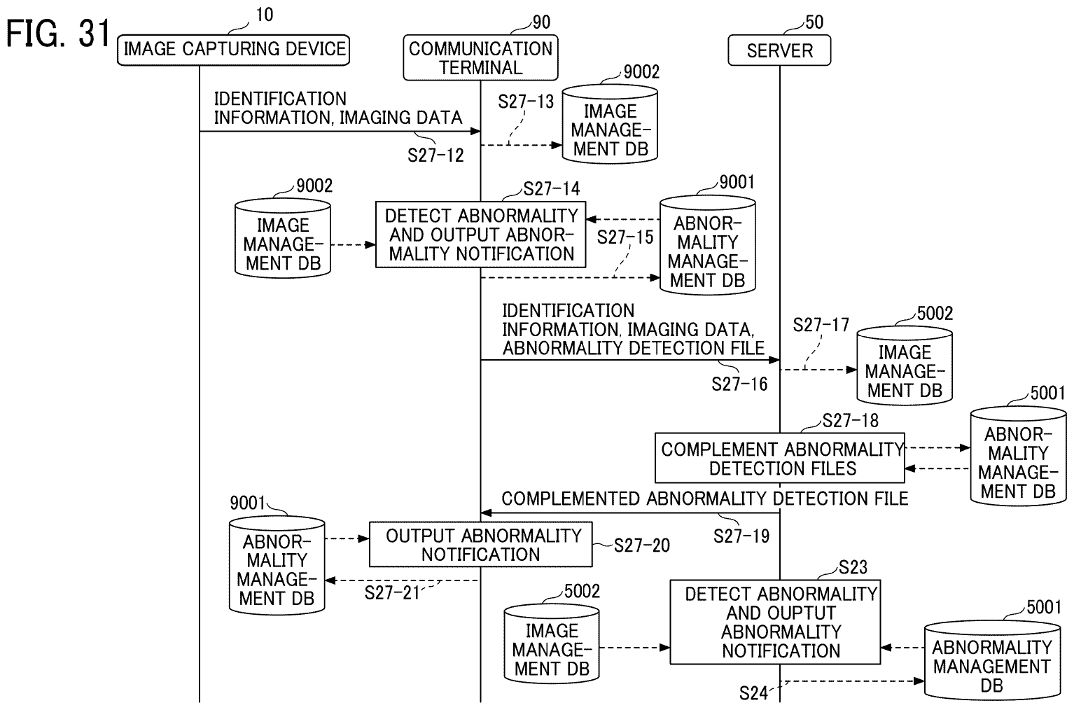

FIGS. 30 and 31 are sequence diagrams illustrating a process of fourth abnormality detection according to the present embodiment. In FIGS. 30 and 31, abnormality detection is set up with the communication terminal 90, and abnormality detection is performed with the communication terminal 90 and the server 50.

The reception unit 92 of the communication terminal 90 receives a user operation to enter a mode for setting up abnormality detection. Then, the reception unit 92 of the communication terminal 90 receives information such as identification information (user ID, model ID, Twin ID, etc.) input by the user (Step S27-1). The transmission/reception unit 91 of the communication terminal 90 transmits the identification information and a request for the abnormality detection settings file of the server 50 to the server 50, and the transmission/reception unit 51 of the server 50 receives the identification information and the request for the abnormality detection settings file of the server 50 transmitted from the communication terminal 90 (Step S27-2). Based on the identification information and the request for the abnormality detection settings file of the server 50 received in Step S27-2, the storing/reading unit 59 searches the abnormality management DB 5001 and reads the abnormality detection settings file corresponding to the identification information (Step S27-3).

When the abnormality detection settings file is not present in the abnormality management DB 5001, the abnormality detection settings file corresponding to the identification information used in the search is created and stored in the abnormality management DB 5001. In this case, the configuration details of the abnormality detection settings file are set to predetermined default settings.

The transmission/reception unit 51 of the server 50 transmits the identification information received in Step S27-2 and the abnormality detection settings file of the server 50 to the communication terminal 90, and the transmission/reception unit 91 of the communication terminal 90 receives the abnormality detection settings file of the server 50 transmitted from the server 50 (Step S27-4).

The storing/reading unit 99 searches, based on the identification information, the abnormality management DB 9001 and reads the abnormality detection settings file corresponding to the identification information (Step S27-5).

When the abnormality detection settings file is not present in the abnormality management DB 9001, the abnormality detection settings file corresponding to the identification information used in the search is created and stored in the abnormality management DB 9001. In this case, the configuration details of the abnormality detection settings file are set to predetermined default settings.

User selection is performed for setting each item for abnormality detection on the abnormality detection settings screen in FIG. 21 displayed on the display 906, and the reception unit 92 receives information on the settings and creates an abnormality detection settings file common to the communication terminal 90 and the server 50 (Step S27-6).

The storing/reading unit 99 stores the identification information generated in Step S27-6 and the abnormality detection settings file in the abnormality management DB 9001 in association with each other (Step S27-7).

The transmission/reception unit 91 transmits the identification information and the abnormality detection settings file created in Step S27-6 to the server 50, and the transmission/reception unit 51 of the server 50 receives the identification information and the abnormality detection settings file transmitted from the image capturing device 10 (Step S27-8). The storing/reading unit 59 stores the identification information and the abnormality detection settings received in Step S27-8 in the abnormality management DB 5001 in association with each other (Step S27-9).

Image Capturing and Abnormality Detection with Communication Terminal

The imaging control unit 13 captures a still image or a moving image by the still image capturing unit 15 or the moving image capturing unit 14 in response to an imaging instruction given according to a user operation (step S27-10). The storing/reading unit 19 stores imaging data representing the captured still image or moving image in the image management DB 1002 in association with an image ID (Step S27-11).

The transmission/reception unit 11 of the image capturing device 10 transmits the identification information and the imaging data (for example, the still image or the moving image) to the communication terminal 90 in response to a predetermined condition, and the transmission/reception unit 91 of the communication terminal 90 receives the identification information and the imaging data transmitted from the image capturing device 10 (Step S27-12). The predetermined condition as a trigger is a condition where the image capturing device 10 is connectable to (can be synchronized with) the communication terminal 90 via the communication network 100 or at the time when the image capturing device 10 ends performing the imaging (image capturing). The storing/reading unit 99 stores the imaging data (for example, the still image or the moving image) received in Step S27-12 in the image management DB 9002 in association with the identification information (Step S27-13).

The abnormality detection unit 96 performs abnormality detection with the communication terminal on the still image or moving image stored in the image management DB 9002 in Step S27-13 in accordance with the abnormality detection settings (Step S27-14). The storing/reading unit 99 stores information on the abnormality detection obtained by the abnormality detection unit 66 in the abnormality management DB 9001 as an abnormality management file (Step S27-15).

Abnormality Detection with Communication Terminal 90

The detection with the communication terminal 90 in Step S27-14 is suitable for processing that is not implemented by the image capturing device 10 in a way that mediates between the image capturing device 10 and the server 50, processing that takes time, or processing that utilizes a function of the communication terminal 90. For example, the communication terminal 90 may output and store the images captured by the fisheye lenses without stitching operation in the imaging (image capturing) in Step S27 10, and may perform the above-described one-sided blur detection on the images captured by the fisheye lenses. Further, the image data after the stitching operation is performed by the communication terminal 90 may be transmitted to the server 50. When abnormality detection is performed by the image capturing device 10, a delay may occur in the imaging sequence due to an increase in processing time. The communication terminal 90 can perform abnormality detection without affecting the imaging sequence.

The transmission/reception unit 91 of the communication terminal 90 transmits the identification information, the imaging data (for example, a still image or a moving image), and the abnormality management file to the server 50 in response to a predetermined condition, and the transmission/reception unit 51 of the server 50 receives the identification information, the imaging data, and the abnormality management file transmitted from the communication terminal 90 (Step S27-16). The predetermined condition as a trigger is a condition where the communication terminal 90 is connectable to (can be synchronized with) the server 50 via the communication network 100. The storing/reading unit 59 stores the imaging data (for example, the still image or the moving image) received in Step S27-16 in the image management DB 5002 in association with the identification information (Step S27-17).

The storing/reading unit 59 searches the abnormality management DB 5001 and reads the abnormality management file corresponding to the identification information received in Step S27-17, compares the abnormality management file of the communication terminal 90 received in Step S27-17 with the abnormality management file of the server 50, and generates an abnormality management file obtained by complementing the two files, if there is a difference between the two files, to store the generated abnormality management file in the abnormality management DB 5001 (Step S27-18).

When the abnormality management files of the communication terminal 90 and the server 50 are different from each other and the complemented abnormality management file is generated in Step S27-18, the transmission/reception unit 51 transmits the identification information and the abnormality management file complemented (generated) in Step S27-18 to the communication terminal 90, and the transmission/reception unit 91 of the communication terminal 90 receives the identification information and the abnormality management file transmitted from the server 50 (Step S27-19).

The abnormality detection unit 96 checks the abnormality management file received in Step S27-19, and when an abnormality error code of an abnormality detected by the server 50 is recorded, the storing/reading unit 99 reads the abnormality detection settings that are configured in Step S27-6 and stored in the abnormality management DB 9001 in Step S27-7. When the error notification is set for the communication terminal, the display 906 of the communication terminal 90 displays the abnormality detection information (the details of an error, an error code, etc.) as a notification (Step S27-20). The storing/reading unit 99 stores the identification information and the abnormality management file received in Step S27-20 in the abnormality management DB 9001 in association with each other (Step S27-21).

The processing after Step S23 is substantially the same as that in the first abnormality detection, and thus the description thereof is omitted.

As described above, an abnormality occurring in the image capturing device 10 can be detected by an appropriate device or method.

The image capturing device 10 or the communication terminal 90 that is an example of a transmission source apparatus, and the server 50 that is an example of a transmission destination apparatus are usable by, for example, a real estate agent who manages or sells real estate, a real estate introducer who introduces properties, and a builder who constructs or manages structures such as buildings, but the application of the present disclosure is not limited thereto.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Although the information processing apparatus, the information processing method, the program, and the information processing system according to embodiments of the present disclosure have been described above, the above-described embodiments are illustrative and do not limit the present invention. The above-described embodiments of the present disclosure may be modified within a range that can be conceived by those skilled in the art. The modification includes additions of other embodiments, modifications, and deletions. The modifications are included in the scope of the present disclosure as long as the actions and effects of the present disclosure are provided.

For example, elements and/or features of different illustrative embodiments may be combined with each other and/or substituted for each other within the scope of the present invention.

Any one of the above-described operations may be performed in various other ways, for example, in an order different from the one described above.

In the related art, abnormality detection is individually performed for each of multiple monitoring cameras and an alert is issued to a system management terminal to report an abnormality to a system administrator when the abnormality is detected. Accordingly, when a failure occurs in the network of the camera, the camera fails to report an alert to the system administrator.

According to an aspect of the present disclosure, an abnormality occurring in an image capturing device can be detected at an appropriate location (device) and method.

1. An information processing system, comprising circuitry configured to:
store, in a memory, setting information in which an abnormality in a captured image and a notification destination for the abnormality are associated with each other, the captured image being captured by an image capturing device;
detect the abnormality in the captured image; and
output, to the notification destination, a notification indicating that the abnormality has been detected.

2. The information processing system of claim 1, wherein
the abnormality and the notification destination in the setting information include a plurality of types of abnormality and a plurality of notification destinations, respectively, and one of the plurality of types of abnormality being associated with one or more of the plurality of notification destinations, and
the circuitry outputs the notification to the notification destination based on the setting information.

3. The information processing system of claim 1, wherein
the setting information includes information on a first device to detect the abnormality and a second device to be the notification destination, each of the first device and the second device being one of the image capturing device and an information processing apparatus communicably connected to the image capturing device, and
the circuitry outputs the notification to the notification destination based on the setting information.

4. The information processing system of claim 1, wherein
the setting information includes details of the abnormality and information indicating that correction is performable on the captured image according to the details of the abnormality, and
the circuitry is further configured to perform the correction on the captured image based on the setting information.

5. The information processing system of claim 1, wherein
the circuitry outputting the notification to the notification destination is included in the image capturing device, and
the circuitry outputs the notification to the notification destination when the abnormality is detected after a predetermined time has elapsed, based on the setting information.

6. The information processing system of claim 1, wherein
the circuitry includes first circuitry and second circuitry, the first circuitry being configured to determine whether the abnormality is present in the captured image and included in the image capturing device, the second circuitry being configured to detect a part of the image capturing device that causes the abnormality in the captured image and included in an information processing apparatus communicably connected to the image capturing device.

7. An information processing method, comprising:
storing, in a memory, setting information in which an abnormality in a captured image and a notification destination for the abnormality are associated with each other;
detecting the abnormality in the captured image; and
outputting, to the notification destination, a notification indicating that the abnormality has been detected.

8. A non-transitory recording medium storing a plurality of instructions which, when executed by one or more processors, causes the one or more processors to perform a method, the method comprising:
storing, in a memory, setting information in which an abnormality in a captured image and a notification destination for the abnormality are associated with each other;
detecting the abnormality in the captured image; and
outputting, to the notification destination, a notification indicating that the abnormality has been detected.
